(19) United States
(12) Patent Application Publication
(10) Pub. No.: US 2005/0283473 A1
(43) Pub. Date: Dec. 22, 2005

(54) Apparatus, method and system of artificial intelligence for data searching applications

(76) Inventors: Armand Rousso, New York, NY (US); Steven Schwartz, Brooklynm, NY (US)

Correspondence Address: CHADBOURNE & PARKS LLP, 30 ROCKEFELER PLAZA, NEW YORK, NY, 10112, US

(21) Appl. No.: 10/946,488

(22) Filed: Sep. 21, 2004

Related U.S. Application Data
(60) Provisional application No. 60/580,471, filed on Jun. 17, 2004.

(51) Int. Cl. G06F 17/30

(52) U.S. Cl. 707/5

(57) ABSTRACT

An apparatus, method, and system for a Artificial Intelligence for Data Searching Applications (AIDSA) that improves upon search systems. The AIDSA enables searchers to better target their searches and yield better search results by intelligently identifying, interrelating, and executing searches including synonyms of keywords. In one embodiment, the AIDSA expands upon a user's query by finding related words and generating all permutations of the user's query and identified related words. Then the AIDSA searches a database based on this expanded query and ranks the results. In one embodiment, the AIDSA super-targets the search results by ranking the results. For example, references having a greater incidence of expanded search terms will be ranked higher than those references having fewer matching search terms. Further, the AIDSA allows users to emphasize certain search terms and this emphasis further targets and affects the search results. In one embodiment, a slider user interface pop-up widget will appear in response to a user highlight a keyword or word phrase and allow a user to set a level of emphasis for the keyword or word phrase. Also, an information bar user interface is taught. The information bar displays AIDSA search results based on the information being viewed by a user.

### FIELD

The present invention is directed generally to an apparatus, method, and system of data searching, and more specifically to an apparatus, method and of searching data using artificial intelligence.

### BACKGROUND

Data Searching

Current computer-based data searching techniques, such as Internet search engines or general computer search methods can return results successfully when there is an intersection of vocabularies as between: a user's inquiry and data source being searched (e.g., a web site's programmers, or a content copy's writer). As such, current search techniques limit the number of relevant results that may be returned. For example, a successful search result is returned when a searcher querying a search engine or a computer database uses the same keywords as did the programmer when writing the META tags for a web site, or the original author of the data source being queried.

### SUMMARY

The invention enables searchers to better target their searches and yield better and more robust search results by intelligently identifying, interrelating, and executing searches including related words of keywords. The invention coordinates with the queried database to identify interassociated items relating to data, and/or any related transactions and acts upon any provided information.

In one embodiment, the AIDSA expands upon a user's query by finding related words and generating all permutations of the user's query and identified related words. Then the AIDSA searches a database based on this expanded query and ranks the results. In one embodiment, the AIDSA super-targets the search results by ranking the results. For example, references having a greater incidence of expanded search terms will be ranked higher than those references having fewer matching search terms. Further, the AIDSA allows users to emphasize certain search terms and this emphasis further targets and affects the search results. In one embodiment, a slider user interface pop-up widget will appear in response to a user highlighting a keyword or word phrase and allow the user to set a level of emphasis for the keyword or word phrase. Also, an information bar user interface is taught. The information bar displays AIDSA search results based on the information being viewed by a user.

In accordance with certain aspects of the disclosure, the above-identified problems are overcome and a technical advance is achieved in the art of searching data. An exemplary method of artificial intelligence based searching follows. The method comprises obtaining a query and matching terms within the query to words in a dictionary of interassociated words. Then the method identifies words related to the matched terms in the interassociated words dictionary and generates an expanded query including identified related words. The method then searches memory with the expanded query and matches references. Finally, the method provides ranked matching references in response to the obtained query.

### BRIEF DESCRIPTION OF THE DRAWINGS

The accompanying drawings illustrate various non-limiting, example, inventive aspects in accordance with the present disclosure:

FIG. 1 is of a logic-flow diagram illustrating embodiments of the present invention to search and provide search results;

FIG. 2 is of a data and logic flow diagram illustrating embodiments of the present invention to search and provide search results;

FIG. 3a is of a data and logic flow diagram illustrating embodiments of the present invention providing an overview of keyword expander, data selector and data ranker components, which enable the AIDSA to better discern the meanings of words, engage in searching and provide search results;

FIG. 3b is of a block diagram illustrating embodiments of the present invention of a web form to accept a query and components;

FIG. 3c is of a block diagram illustrating embodiments of the present invention of an information bar;

FIG. 3d is of a block diagram illustrating embodiments of the present invention of an information bar with a similar sites facility;

FIG. 4 is of a data and logic flow diagram illustrating embodiments of the present invention detailing a keyword expander;

FIG. 5 is of a data and logic flow diagram illustrating embodiments of the present invention detailing a data selector;

FIG. 6 is of a data and logic flow diagram illustrating embodiments of the present invention detailing a data ranker;

FIG. 7 is of a block diagram illustrating embodiments of related word generation and AIDSA result rankings; and

FIG. 8 is of a block diagram illustrating embodiments of the present invention of an Artificial Intelligence for Data Searching Applications controller.

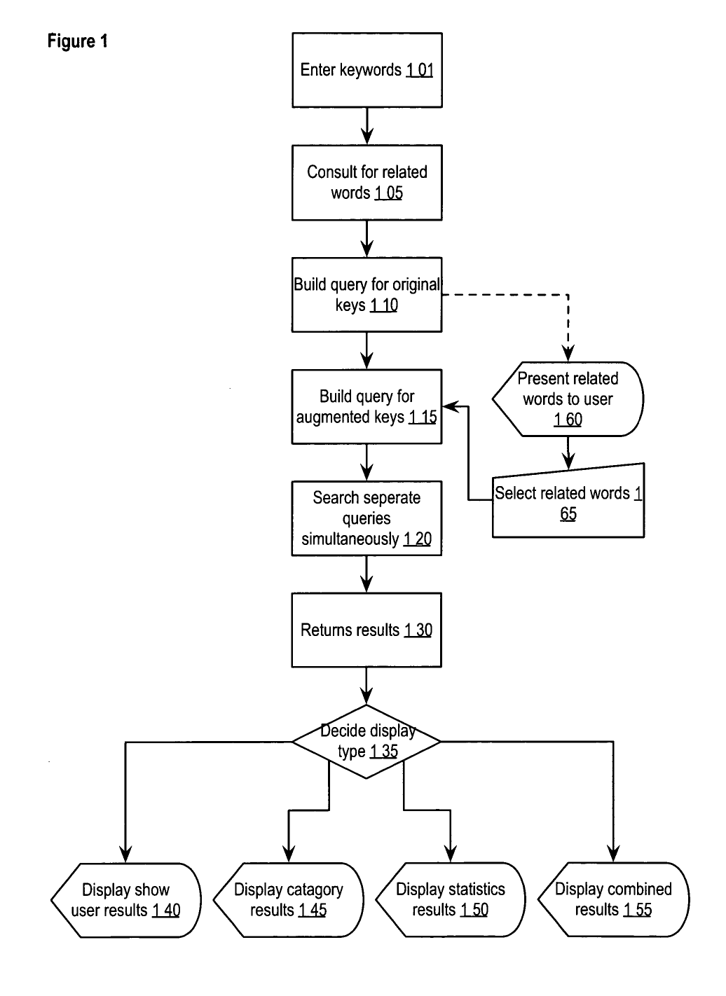

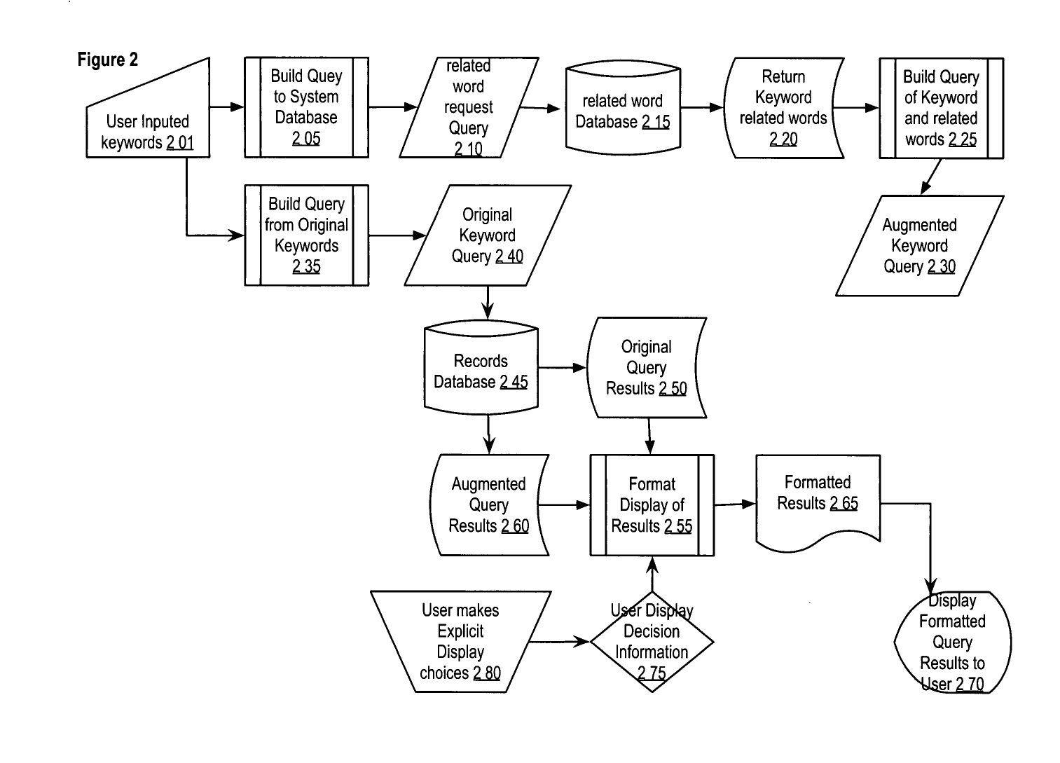

The leading number of each reference number within the drawings indicates the first figure in which that reference number is introduced. As such, reference number 101 is first introduced in FIG. 1. Reference number 201 is first introduced in FIG. 2, etc.

### DETAILED DESCRIPTION

The disclosed Artificial Intelligence for Data Searching Applications (hereinafter “AIDSA”) improves upon current searching systems. To date, no effective and widely deployed solution exists to hone and/or intuit queries and subsequently provide a robust range of relevant search results. In general, search results are affected by two things: the keywords the user inputs for a search, and the keywords used to index data within data source being searched (e.g., a search engine or computer database, etc.).

With current search techniques, incomplete and unexpected search results are returned (in terms of the real data available) when search keywords, colloquial, and/or local terms are not anticipated or unexpected. To put it simply—the input directly limits the output. Thus, with current systems, input of inappropriate keywords will yield inappropriate results or no results altogether. Yet the searcher may not realize the keywords are inappropriate based on their desired results, and may even be been unaware that other relevant responsive information exists or that more appropriate keyword/search alternatives may exist.

Building an understanding of the searcher can allow the search approach to form a context for each user that will guide the search process. While the building and use of a contextual profile may be an asset in some cases, in other cases it may be a liability in others. As such, context may be better used as a component of the AIDSA.

Artificial Intelligence for Data Searching Applications

FIG. 1 is of a logic flow diagram illustrating embodiments of the present invention to search and provide search results. The AIDSA augments and expands a searcher's vocabulary by producing related keyword query terms that may be more suited to what the user is actually looking for.

At this point, it will be helpful to list some of the concepts regarding word meanings that the AIDSA understands. The following table details various types of word relations. Nouns, verbs, adjectives, adverbs, stems, and phonetic qualities of words are known by the AIDSA. The following table illustrates various related word types.

| | Description |
|---|---|
| Nouns | |
| synonyms | Words with similar meaning |
| hypernyms | Y is a hypernym of X if every X is a |
| | (kind of) Y |
| hyponyms | Y is a hyponym of X if every Y is a |
| | (kind of) X |
| coordinate terms | Y is a coordinate term of X if X and |
| | Y share a hypernym |
| holonym | Y is a holonym of X if X is a part of Y |
| meronym | Y is a meronym of X if Y is a part of X |
| Verbs | |
| synonyms | |
| hypernym | the noun Y is a hypernym of the verb X |
| | if the activity X is a (kind of) Y |
| coordinate terms | those verbs sharing a common hypernym |
| Adjectives | |
| synonyms and related nouns | |
| antonyms | adjectives of opposite meaning |
| Adverbs | |
| synonyms and root adjectives | |
| antonyms | |
| Stem | Portion of a word. Usually the root. |
| Phonetic | Sound of word. |

Dictionaries with mappings between words may be obtained. For example, WordNet <http://www.cogsci.princeton.edu/˜wn/> provides a mapping architecture as between related words. In one embodiment, words are organized in an interrelated and weighted graph topography where a hierarchy may be derived. For example, the word “running” might be viewed as part of a “track meet” when the two word/phrases point to each other in the directed graph topography. In one embodiment, the AIDSA maps related words from one language to another, e.g., English to French as a part of the keyword expansion 465.

Using the search method described herein, an additional expanded search is automatically created. The AIDSA creates the search transparently from the perspective of the user. This search generates related words to the keywords entered by the user. In one embodiment, the original search and the expanded-search may be executed simultaneously. It should be noted that throughout this disclose any time such original and expanded searches are noted they may execute simultaneously, in an alternative embodiment, the searches may be executed individually, and not simultaneously, or in another alternative embodiment, only the single expanded search might execute.

In one embodiment, the searcher enters keywords for the search in the search vehicle (e.g. a search engine, computer, etc.) 101. Then, the search vehicle consults an internal database for keyword related words 105, and adds them to a key list if found. Also, the search vehicle builds a query for original keys 115. Similarly, the search vehicle builds a query of expanded, i.e., augmented, keys 115. Next, the search vehicle executes separate queries 120. Then the search engine returns results 130.

The search vehicle can display results based on user and/or device configurable options 135. Display methods may include, but are not limited to the following: showing user search results, asking about displaying augmented results 140; showing categories for user search results, then showing alternate categories from augmented results, and displaying user search results below them 145; displaying results statistics and offering user choice of displaying each set of results 150; and, displaying combined set of results 155.

In one optional embodiment, it is also possible to present a list of related words to the user before a query is executed 160, allowing the user to select those that they feel are most appropriate 165. This has the advantage of optimizing actual search response time.

FIG. 2 is a data and logic flow diagram illustrating embodiments of the present invention to search and provide search results.

In one embodiment, the searcher enters keywords for search in search vehicle 201. Then, the vehicle engine consults an internal database for keyword related words 215, and adds any related words to a key list if found 220. Also, the search vehicle builds a query for original keys 235. Similarly, the search vehicle builds a query of augmented keys 225. Next, the search vehicle executes separate queries 230, 240. Then the search vehicle returns results 250, 260.

As described above, the search vehicle displays results based on user and/or engine configurable options 270. Display methods may include 255, but are not limited to the following: showing user search results, asking about displaying augmented results 275, 280; showing categories for user search results, then showing alternate categories from augmented results, and displaying user search results below them; displaying results statistics and offering user choice of displaying each set of results; and, displaying combined set of results

In one embodiment, it is also possible to present the related words to the user before a query is executed, allowing the user to select those that they fell are most appropriate. This has the advantage of optimizing actual search response time.

Search Constructs

In one embodiment, the AIDSA may accept a list of keywords for a search 201, and optionally, additional relevant parameter information, e.g., the geographic locale of the user submitting the search query. The AIDSA can then check each keyword against a database of related words 215, and return a list of related words for each keyword 220. As an option, the list of related words returned may be modified by the geographic locale of the user, or the other relevant search parameters.

Example query construct:

Original:
keyl, key2, key3

Augmented:
keyl, keyl OR synl, keyl OR syn2, key2, key2 OR synl, key2 OR syn2, key3, key3 OR syn1, key3 OR syn2, keyy3 OR syn1 OR syn2, syn1, syn2, syn1 OR syn2

In the above example, syn1 and syn2 are the only related words found in the database and are used to make an augmented search including every combinatorial combination of keywords and related words. It should be noted that a parameter may be specified to limit the number of combinations to be used in the augmented search. For example, a parameter flag <search combinations limit=3> would create only three augmented combination keywords to augment the original search.

In an alternative embodiment, two database queries are built by the AIDSA; a straight query with the user supplied keywords, and an augmented query with related words (see example below). The augmented query contains the original keyword, and nested “OR” groups containing related words for each keyword as well as the original keyword.

Example augmented query construct:

Original:
WHERE RECORD CONTAINS (keyl AND key2 AND key3)

Augmented:
WHERE RECORD CONTAINS ((keyl OR keylsynl OR keylsyn2) AND (key2 OR key2synl OR key2syn2) AND (key3 OR key3syn1 OR key3syn2) AND key3syn1syn2 AND (syn1, syn2, syn1syn2))

In one embodiment, the original keywords may be taken completely out of the augmented query and only the related word permutations would be used as the basis of the query. This may even be controlled by a query parameter, for example:

Original:
WHERE RECORD CONTAINS (keyl AND key2 AND key3)<limit search to related words><limit related words=synonyms><limit number of related words=2>

Augmented:
WHERE RECORD CONTAINS (syn1, syn2, syn1syn2)

As can be seen above, codes may be generated to limit the search to only related words. Also, the types of related words to be used may be specified, e.g., in the above example only synonyms are to be used to create the expanded search. Also, the number of actual related words may be specified, e.g., here only two synonyms were specified and generated. It should be noted that the user may specify such codes by hand, or a GUI may provide, e.g., popup controls for creating search constraints that will generate the proper parameter codes for the user's augmented search. When limiting the search terms, in one embodiment, the statistically most popular related words are given priority when generating the augmented search. For example, if the number of related words is limited through a parameter to “2” then the two most popular or most common related words to the supplied keywords would be used in generating the augmented search. In one embodiment, when related words are being identified, pronouns are given less weight or not used; as pronouns are somewhat non-specific in nature, in many cases this enhances the targeting of the augmented search.

In another embodiment, the AIDSA may simultaneously submit two queries to the AIDSA database (which contains results records) to generate a query-specific group of results. The specific results of the database queries will be displayed to the user based on methods as has already been described 170. Optionally, the user may be asked to select keywords from the list of related words returned from the database of related words before queries are generated. This will provide the most flexibility in guiding the user to an appropriate query form, rather than forcing a program generated query upon the user.

As such, some search technologies attempt to implicitly limit search results based on a context record generated from historical user search activity information. The present method provides a user with the ability to generate an informed search by explicitly selecting system supplied related keywords to augment user provided keywords, or to explicitly accept a query of system augmented keywords. The present method should not be confused with search engine technology that offers a user alternate keywords of varied spelling combinations. Those methods focus on keyword replacement based on spelling, but cannot distinguish and/or identify similar and/or colloquial meanings.

Various Applications

The present method is a keyword method that may be applied to any type of keyword or data search; it is equally valid in searches against databases, flat files, and/or any group of data where a keyword may be compared against elements of a data group. In one embodiment, voice recognition may be used to obtain initial query terms and to provide and select from related words. For example, voice activated toys would respond more appropriately as they would be able to identify appropriate responses more robustly. In a voice recognition system, a related words database may be embedded within the device, e.g., toy. When a user speaks their request, a speech-to-text unit converts the speech into text, and the resulting text is then used to form a query. In such an example, all the words are used to lookup related words. Then, after the related words are identified, they are compared against a set of known commands. For example, if a toy doll understands a the commands “What is your name” and “How old are you” and nothing more, augmented searches that have more keywords matching the first or the second command will be interpreted to match the respective command. This is an extremely useful user interface augmentation as users generally will not know or bother to memorize a command set. In this manner the AIDSA expands the user's command request into a search and increases the chances of finding their desired command through search augmentation. This will allow users to issue commands more naturally to voice activated devices.

In another embodiment, dynamic advertising may be generated. An embedded code insert may be provided to those that wish to have advertising on their web sites. The code applet would take the content of the current page being viewed by the user and submit the entirety of the article text as a query to the AIDSA as a single large query. In an alternative embodiment, the query may be comprised of metadata keywords in the web page or it may be based on just the title of the web site article. Then a database of ads is searched by the AIDSA and the top results are sent back to the applet and they are displayed as ads accompanying the web page being viewed by the user. Advertisers would pay to have their ads make up the corpus of the ad database, and/or pay for when their ads are viewed by users. Web sites that use the applets could receive compensation as part of the advertising revenue stream.

In another embodiment, searches may be conducted on an e-mail database to locate data sent by someone, and/or on a specific subject. Voice recognition and/or other descriptions may be used as a starting point, and the present method would then generate related words and conduct a search. In yet another embodiment, the AIDSA may be used to search for profiles in a government database. For example, customs databases may be used to search for terrorists by returning more robust results based on supplied criteria; such results would increase the chances of identifying sought targets. In yet another embodiment, the AIDSA may be used to aid in e-commerce by providing more intelligent search results for customer product-based queries. In still another embodiment, Internet search engines may be enhanced by the AIDSA to provide more intelligent and meaningful search results.

Meanings of Words for Data Searching

Overview

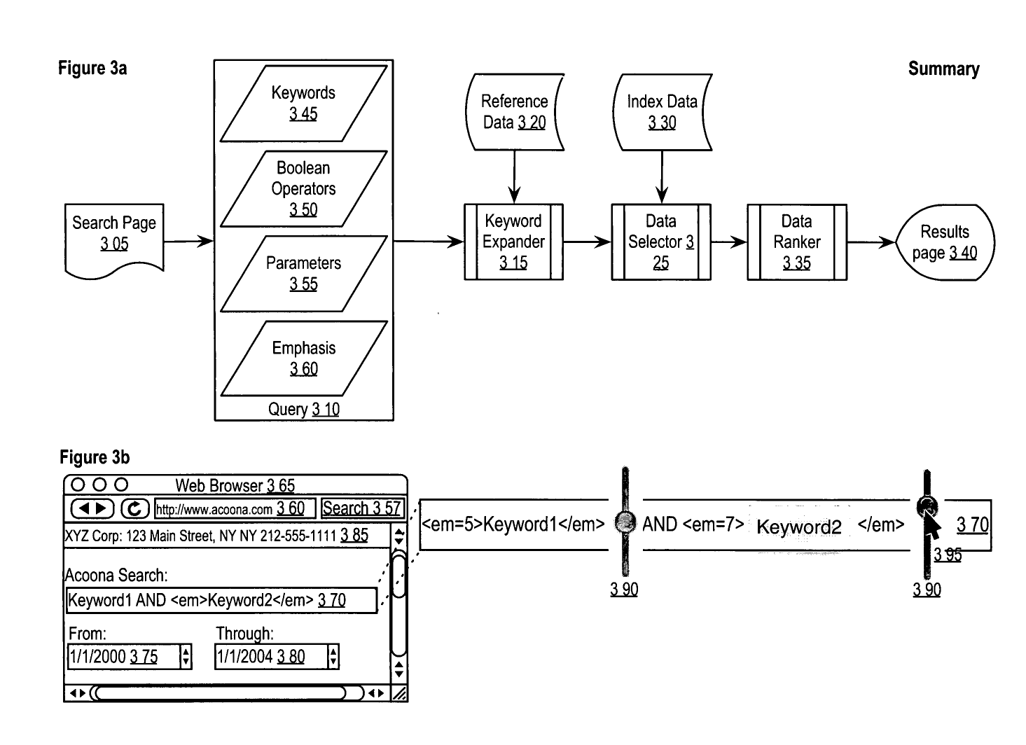

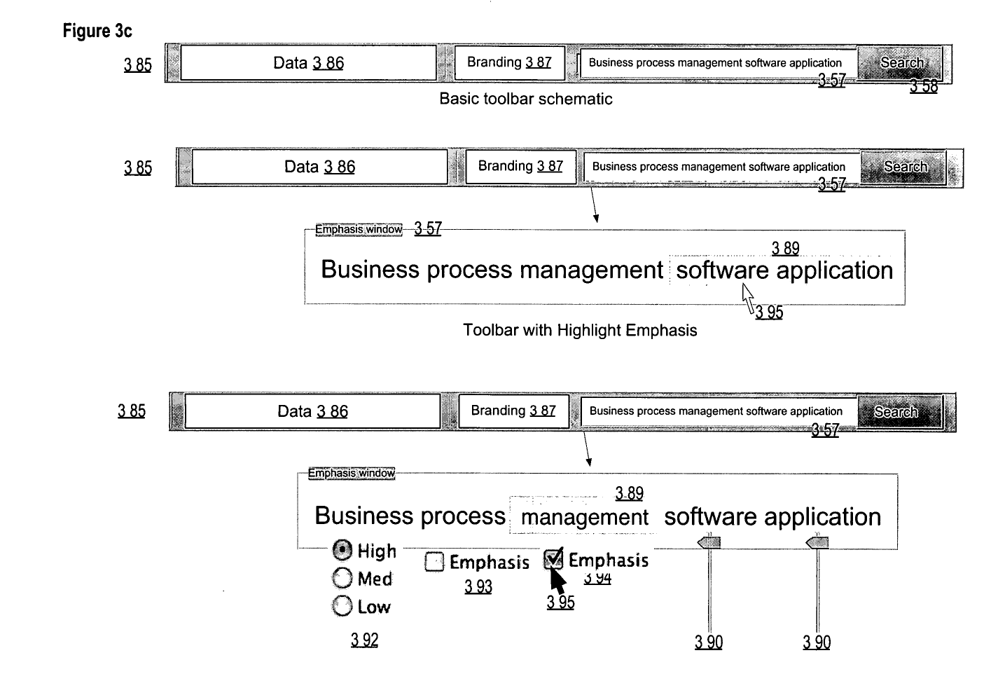

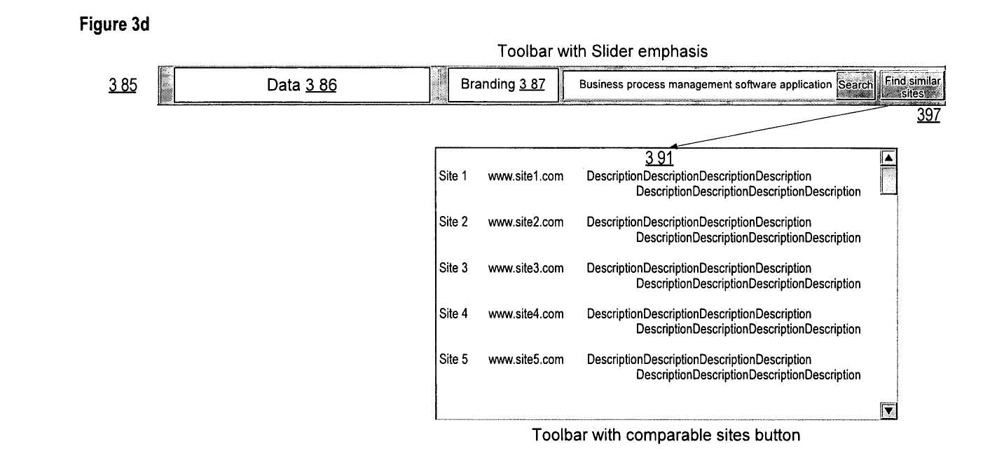

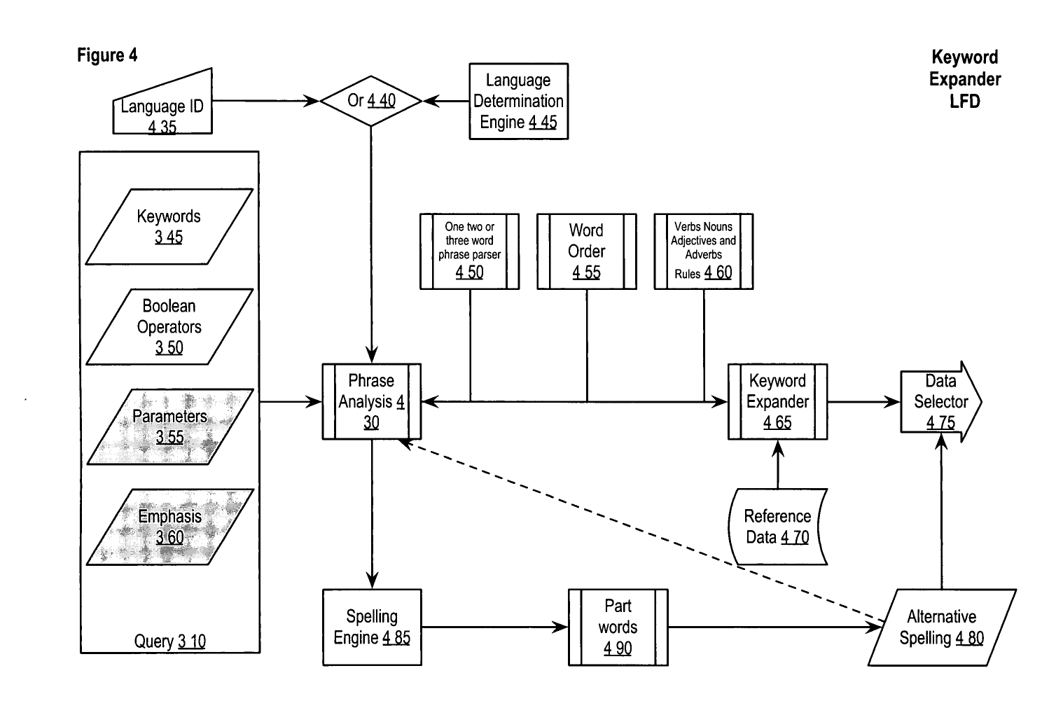

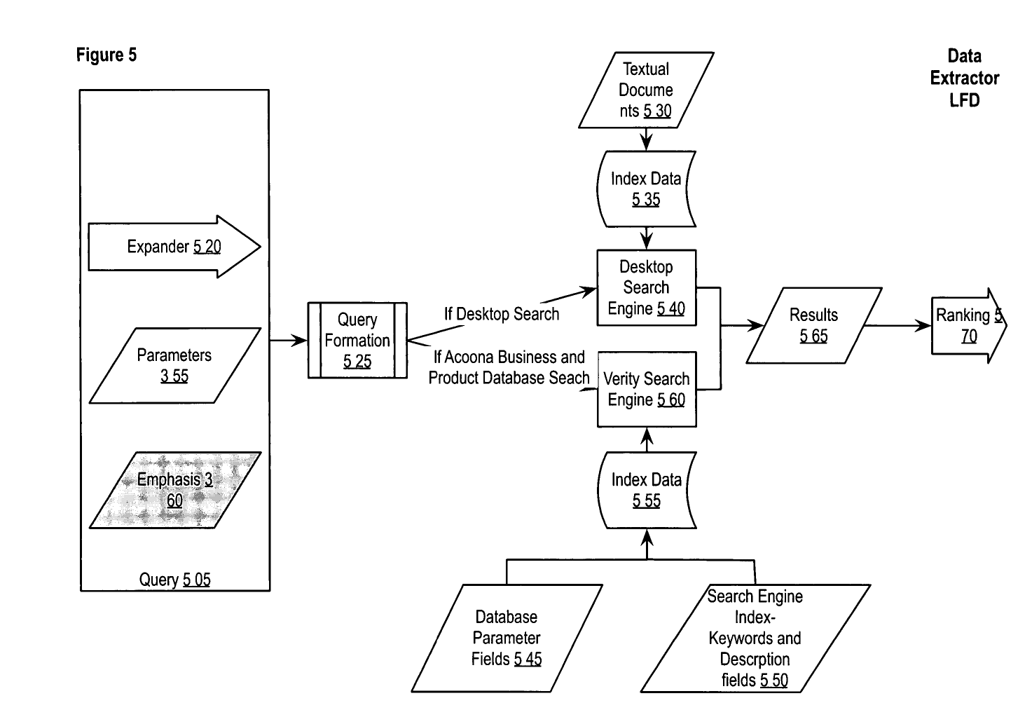

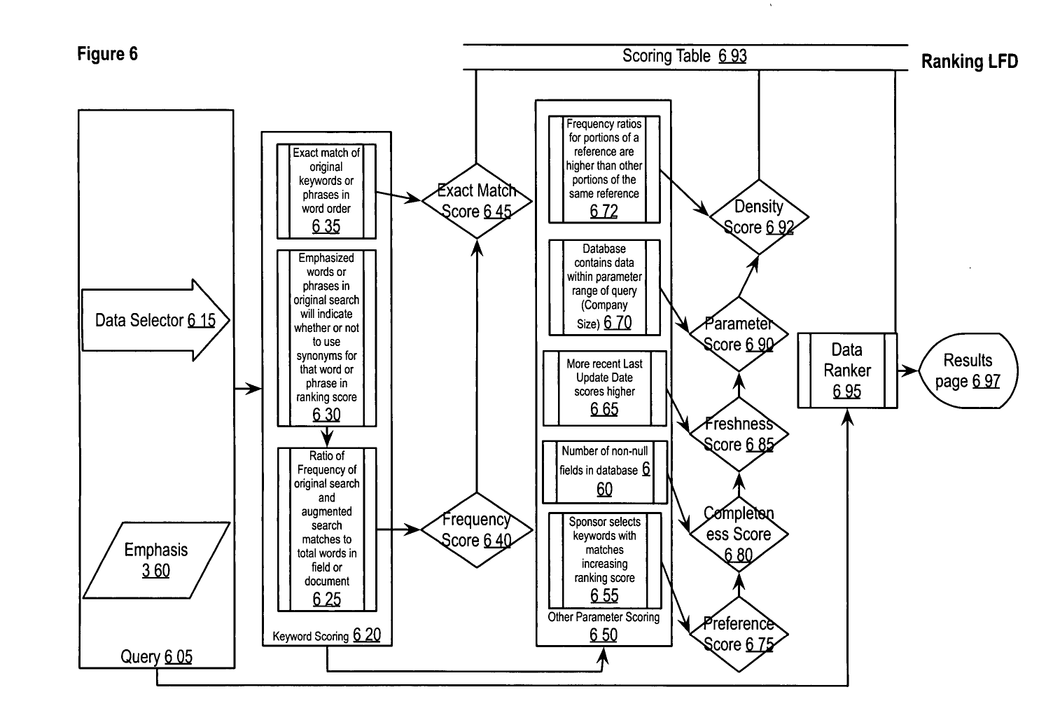

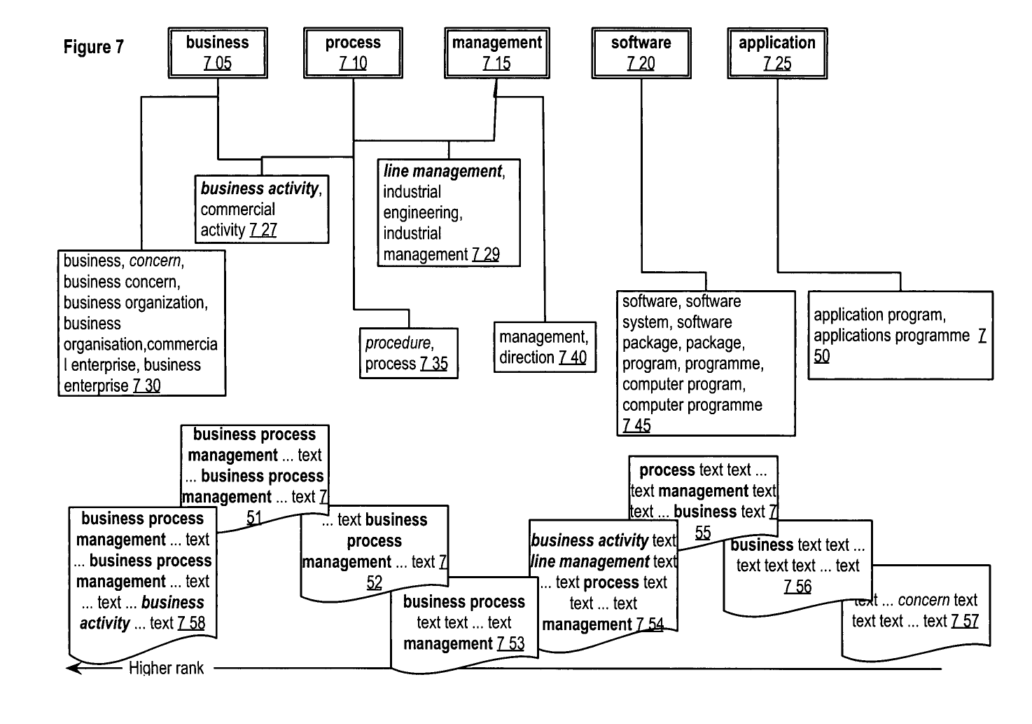

FIGS. 3-7 are mixed block, data and logic flow diagrams illustrating embodiments of the present invention to discern the meanings of words, search and provide search results. The ability of the AIDSA to generate related augmented keyword searches to expand the user's search and the intelligently limit the results with intelligent ranking allows the AIDSA to better determine the meanings behind the users search and provide better results. In particular, FIG. 3a is of a mixed data and logic flow diagram illustrating embodiments of the present invention providing an overview of keyword expander 315 (see FIG. 4), data selector 325 (see FIG. 5) and data ranker 335 (see FIG. 6) components, which enable the AIDSA to better discern the meanings of words, engage in searching and provide search results.

Discerning a user's search meaning starts with a user navigating to a search outlet 305. Typically, a search page may be presented to the user with web form and text fields into which a user may enter keywords 345, Boolean operators 350, various parameters 355, and emphasis 360 thereby generating a query 310. Moving to FIG. 3b for a moment, will provide greater detail as to how such query components 345, 350, 355, 360 may be provided to the AIDSA.

FIG. 3b is of a block diagram illustrating embodiments of the present invention of a web form 390 to accept a query 310 and components. The AIDSA may store an HTML web form 390 that may be accessed by various web browsers through its information server. The address 360 resolves to the AIDSA's web server, which in turn will provide the web form 390 to the user's web browser 365 for display and interaction. In one embodiment, keywords 345, Boolean operators 350, parameters 355 and emphasis 360 may all be entered in a text box 370. Keywords 345 comprise the general area of interest that a user is concerned with. Boolean operators may simply be entered and parsed as such, i.e., “and,” “or,” “not” and “exclusive or,” which act to connect the various keywords.

Emphasis may be provided by way of code tokens, e.g., <em></em> surrounding a keyword or phrase that is to be emphasized. Emphasis may instruct the AIDSA that some search keywords are more or less important to the user than others. Also word order can provide emphasis when several keyword search terms are being used; for example, the first word may be deemed to have more emphasis than the following keywords. In one example, emphasis may be provided via a pop-up slider widgets 390. Such a graphical user interface allowing a user to provide emphasis through highlighting and widget interaction greatly reduces the complexity of the interface. This interface increases ease-of-use and allows a user to interact and provide emphasis with their query in a more natural manner. The user may highlight a word, e.g., Keyword2, and a javascript slider would appear in response to the selection 393, where the user may increase the emphasis by setting the slider value with the cursor 395. In such an example, emphasis codes would reflect the weights given, e.g., <em=7> would have a greater specified emphasis for a word as compared to <em=5>. In one embodiment, terms having greater emphasis cause the AIDSA to recursively search for more related terms in its dictionary. For example, after related words are obtained for all the query terms, for those terms that have greater emphasis, the AIDSA may further search for words related to the emphasized term's related words. In one embodiment, as the user changes emphasis values, the query is continually being re-executed based on the varied emphasis values, and search results are changed and shown to the user interactively.

In one embodiment, emphasis applied to keywords is also applied to any related words. As such, if a keyword “jog” receives an emphasis score of 7, then all related words identified by the AIDSA, e.g., “run,” will also obtain an emphasis score of 7. In an alternative embodiment, all words related to an emphasized keyword will receive decaying emphasis. For example, if a keyword “jog” has an emphasis value of 7, then a related word “run” will have an emphasis value of 6; furthermore, any subsequent recursive related words would have further decayed emphasis values.

Finally, parameters 355 may specify constraints on query components, e.g., parameters may be used to limit search results by geography, time, cost, etc. Alternatively, a web form 390 may be provided where query 310 components are separated and the user may build a query through the entry of multiple text boxes and other user interface widgets. For example, parameters may be supplied by way of popup boxes 375, 380 that allow the user to limit search results to matches from a given date 375 up and through another specified date 380. However, the AIDSA is not limited to a web form 390 implementation. It may also be implemented in stand-alone, framework, plug-in and other forms. In one embodiment, a search panel 355 is integrated into a web browser 365 by employing the web browser's plug-in and/or API architecture. In such an implementation, a query may be specified in the search panel 355 and it will be submitted to the AIDSA without first having to navigate 360 to a web site. In another embodiment, an information bar 385 may employ the AIDSA. In such an embodiment, either queries made from the search panel 357 or the current address 360 may be used as the basis of a query. For example, if the current address points to www.acoona.com, the information bar 385 will submit “acoona” and any identifying metadata from “www.acoona.com” as a query to the AIDSA and retrieve the most relevant information for display in the information bar. In another example, a user may be surfing the web and visit a pizza web site, Acme Pizza, and the information bar will retrieve information through the AIDSA from a remote database about Acme Pizza without the user specifically typing in a search query. In other words, the user's surfing behavior will cause the information bar to display the information, such as Acme Pizza's telephone number, without the user specifically using the information bar, but instead the information bar will be responsive to what the user is viewing in the web browser. In one embodiment, the information bar displays contact information. However, the information bar may be modified to show any related information. In one embodiment, a web site may embed tags in its web page to direct the information bar with the types of information that should be displayed, e.g., <info bar show=Value><info bar query term=Value>. Such tags may direct the info bar to simply display a value, or pass a value as a query to the AIDSA, which in turn will be used by the info bar. In another embodiment, the information bar 385 may display links to comparable companies or products similar to those being viewed 390. In yet another embodiment, advertisers may pay to have links to their goods and/or services come up as related links when the user traverses certain locations 360, i.e., Company A may wish its links to be displayed in the information bar 385 whenever Company B is visited 360 by the user.

FIG. 3c is of a block diagram illustrating embodiments of the present invention of an information bar 385. In one embodiment, the information bar shows data 386, and provides a search panel 357 as has already been discussed in FIG. 3b. In another embodiment, the information bar also provides a location for branding 387. The branding location may load a graphic or textual identifier. For example, the branding location may show the provider of the information bar, e.g., Acoona, an ISP, an sponsored advertisement, and/or the like. Also, the information bar may provide a search button widget 358 that is engageable by a user to issue a query based on information entered into the integrated search panel 357. The information bar allows a user to enter search terms into the search panel 357 and select individual words and/or phrases 389, for example, by clicking and highlighting the text with a cursor 395; in other words, merely highlighting the text with nothing more provides a binary emphasis weight. It should be noted, that the information bar also allows the searching of a the user's desktop computer. In a previous embodiment in FIG. 3b, Keyword 2 was highlighted in a search panel and emphasis codes were visible around the highlighted term 370. In another embodiment, when a user selects terms, e.g., “software application” 389, the emphasis tags are not displayed in the emphasis panel 357, and instead the terms are highlighted visually. The tags may be present but not displayed and thereby make the process of emphasizing terms more user friendly for users. Another advantage of such visual emphasis is that highlighting can also establish word phrases. In another embodiment, emphasis selection may be similarly achieved by highlighting words or phrases, e.g., “management” 389, but user interface widgets will be displayed adjacent to the selected word and/or phrase. Various user interface widgets may be used. In one embodiment, radio buttons may appear allowing a user to specify degrees of emphasis, e.g., high, medium or low emphasis 392. Check boxes may appear allowing a user to emphasize 394 a word (e.g., “management” 389) or not 393. And as already discussed in FIG. 3b, slider widgets 390 may be used to set varying levels of emphasis.

FIG. 3d is of a block diagram illustrating embodiments of the present invention of an information bar with a “similar sites” facility. In one embodiment, the information bar 385 is augmented with a mechanism to find similar sites 397, e.g., a button widget. By engaging the find similar sites mechanism 397, the information bar will use the current address being visited by the user 360 as a basis to create a query and find sites similar to the currently visited site. For example, if a user is visiting AcmePizza.com, and engages the find similar sites facility 397, a query for “acme pizza” may return a number of comparable web sites in the users web browser 391. In one embodiment, when looking for comparable sites, the information bar would supply a query to a database limited to providers of goods and/or services, rather than to a more free-form/topic-agnostic database or search index.

Moving back to FIG. 3a, once a search page 305 has been traversed and a query 310 and its components have been provided, the query may be sent to the AIDSA, e.g., by way of HTTP post command. Upon receiving the query via the AIDSA's information server, it is passed to the keyword expander 315. The keyword expander 315 receives the query 310 and expands the terms for searching by employing reference data 320. The details of this expansion were already discussed in FIGS. 1 and 2 and will be discussed in further detail in FIG. 4, e.g., every permutation of the keyword and its related words are generated. The reference data 320 may be stored in a table in the AIDSA database. After the keywords are expanded 315, the expanded terms are provided to a data selector 325, which matches the expanded search terms against index data 330 thereby identifying references responsive to the query. The number of responsive references may be limited by query constraints such as the Boolean operators 350, parameters 355 and emphasis 360. Thereafter a data ranker 335 obtains selected responsive references and ranks the findings. Here the various query constraints such as emphasis 360 may be used to affect the rankings. For example, references that have more instances of an emphasized keyword will be ranked higher than non-emphasized rankings. In another embodiment, fuzzy logic parameters may be used to weigh rankings rather than act as cutoff. For example, if a date range parameter is provided, matching references falling within the range would be ranked higher than those falling outside the range. The ranked results are then provided for display to the user, e.g., via a web page 340.

Keyword Expander

FIG. 4 is of a data and logic flow diagram illustrating embodiments of the present invention detailing a keyword expander. The query 310 is provided to a phrase analyzer 430. In one embodiment, the AIDSA determines the language being employed by the user's query. In one embodiment, the user simply engages a pop-up menu or other user interface widget indicative of the language being used 435. Alternatively 440 a language determination engine 445 may analyze the query text and determine which language is being employed by the user. In one embodiment, query terms are searched against numerous language dictionaries and perform a statistical analysis of which dictionary provides the highest rate of matches. The highest number of terms matched would form the basis of the language determination. Language determination and lookups to a dictionary already provides greater context and insight into the meanings of words. In one embodiment, language translation dictionaries may be used to create associations of one word in one language to its translated form in another language. This may be used to broaden searches into international scope. For example, interlinked language dictionaries such as those used by BabbleFish.com may be used for further keyword expansion.

The phrase analyzer 430 also contemplates identifying various alternative spellings of query terms via the spelling engine 485. Alternative spellings and misspellings can often increase the number of the search terms and subsequent matching search results. This is initially done by passing the query 310 terms to a spelling engine 485. The terms may be parsed and tokenized in XML tagged or plain text format.

In one embodiment, the spelling engine 485 can correct and/or otherwise determine the correct spelling for any provided query terms. In the case where provided query terms are misspelled, then correct spellings are found. The spelling engine employs a database of related words, e.g., WordNet, as has already been discussed. Partial words are also important in the determination and in creation of a broad base search. The system can generate partial root words 490 from the corrected spellings of query terms 485 and break down various words from the query into root components 490. The AIDSA's related word database allows for stems and stem variants to be identified—all of which may be used to increase the number of related query terms that are to be used by the search engine. In one embodiment, in addition or instead of partial word generation 490 by the AIDSA, phonetic word variants and phonetic stems are identified. In another embodiment, stems and phonetics are used to identify related words in different languages. These related query terms 490 are provided and alternative spellings may be provided for the query terms as well as the common misspelling of those words. Partial words may be determined by looking up a keyword in the, e.g., WordNet, dictionary database; when a keyword is matched, the dictionary will supply a root word for the match and any related words. Also, a database of common misspellings may be generated over time by tracking corrections made by the spelling engine 485. By generating alternative and common spellings and misspellings, the AIDSA increases the chances of finding references that discuss the topic of interest desired by the user. In one embodiment, the expanded query 480 may be provided back to the phrase analyzer 430, which in turn will expand the query terms further 465. Then all the alternative spelling suggestions and partial words 490 are at that point provided to the data selector 475, and they will be added to the expanded query from the keyword expander 465 and sent as a single expanded query to the data selector 475.

The phrase analyzer component 430 analyzes the query 310 provided structure on behalf of the keyword expander 465. Several components 450, 455, 460 help the phrase analyzer with the query. The phrase parser 455 determines if several of the keyword terms in the query are in fact a single phrase. In one embodiment, a user may tag two or more keywords to be a single phrase, e.g., by putting the phrase in quotes. However, the phrase parser may also lookup each of the keywords in its related words dictionary and see if other keywords in the query may be used to make up a word phrase and/or idiomatic expression. For example, three keywords may be: “track,” “meet” and “field.” The phrase parser can determine that there are three separate terms, but it can also determine that “track meet” and “track and field” are to be treated as phrases by performing searches on the AIDSA related words dictionary database. This is a powerful addition as it will expand a users search meanings intelligently. For example, if the user is looking for information on the internet about “cat food” the phrase analyzer will generate related phrases of “cat chow” instead of related words just for the individual words “cat” and “food,” which allows the AIDSA to better get at the meanings behind the user's search.

Also, a word order analyzer 455 may be used to give greater meaning to the query terms 310. For instance, in our above example, “track” and “field” are separated by the word “meet,” and so it is more likely that the user intended “track meet” to be phrase than “track and field,” therefore, word order 455 can create emphasis for various permutations of meanings from the phrase parser 450. Further, word order can help the determine the grammatical type of the word. For example, if the search query is “reviews that run cars with liquid fuel” then the word “run” would be interpreted to more likely be a verb as it is in the middle of the supplied query. In an example where the search is “the run that caused people to get very tired” the AIDA would interpret “run” top be a noun as it is towards the beginning of the query where the subject is typically specified. As such, word order can provide greater context and emphasis to provided queries.

For all groupings of two or more keywords that are found in the AIDSA related words dictionary as also constituting a phrase, such phrases will be marked as a phrase. Also an analysis is performed on which keywords are likely to be a verb, noun, adjective, adverb etc. By tagging the query tokens with various grammar types, relationships between words may be traversed providing a better basis with which to expand the query. For example, the related word database identifies synonyms and antonyms for any word based on the word's grammatical form. As such, if a keyword is both a noun and a verb, the keyword expander may search for related words restricted to noun and verb forms. In an alternative embodiment, emphasis is given to related words with the same grammatical form as the query terms, but other related words that are of a different grammatical form, e.g., an adverb, are given less emphasis.

The phrase analyzer 430 components 450, 455, 460 analyzes queries by performing lookups against the related words dictionary. The phrase analyzer will find matches, and mark the query terms to identify phrases, word order emphasis 455 and grammatical tags for the words 460. This tagged query will allow the keyword expander 465 to generate more accurate and relevant expanded keywords. The keyword expander 465 may do so by employing reference data 470. Reference data 470 may be stored in the AIDSA database. The related words database contains various related word interassociations. Thus for each of the query terms 460, related words are identified by the keyword expander 465 by performing searches on the related words database. Related words are collected. In alternative embodiments, hypernyms, hyponyms, antonyms, proximate coordinate terms, etc. are used as the basis of lookups in the related word database to further expand identification of related words. Upon expending their original keyword terms 465, that query 465 is combined with any alternative spellings 480 and/or partial words 490 and provided to the data selector 475.

Data Selector

FIG. 5 is of a data and logic flow diagram illustrating embodiments of the present invention detailing a data selector. Continuing 475 from FIG. 4, the expanded 520 query 505 terms are provided to the data selector. This expanded set of keyword terms is provided to the query formation component 525. The query formation component 525 determines the target of the search, i.e., a determination is made as to what type of search engine and index data will be used for querying. For example, in one embodiment, a desktop computer may have a search engine 540 interfacing with an AIDSA and contain index data 535 that was created solely from documents 530 on the desktop PC. In another embodiment, a centralized and/or web search engine 560 may use index data 555, which is generated by spidering and/or otherwise culling data by traversing the internet or some other body of references. For example, the spider may be directed to follow all hyperlinks from a given site, and have parameters that limit its indexing to only web pages that have been updated in the last month. In such an embodiment, the spider would index every occurrence of a word and provide a pointer or other reference as to where the word may be found. For such a network search engine 560, various database parameter fields 545 and/or search engine keywords and description 550 may be used as a basis of mining or otherwise indexing 555 a larger and more widely deployed data set. For example, when web pages are spidered for information, metadata tags, e.g., XML parameter tags and/or field descriptors, may be used to index words within the web pages as specific types of data and/or the data may be indexed into specific types of database indexes. For example, a company's contact web page may specify name, address, zip code, etc. fields and values; as such, parameter fields 545 and or keywords 550 may be established to take such information and index it into a specific company database. In such an example, a parameter field may specify that all five digit numbers following a two-letter state code 545 are to be indexed under a zip code keyword 550 in a companies database (i.e., a database specific to information about various companies). In another embodiment, the network accessible database may be an advertising database as was already discussed in FIG. 2. Such a database would be populated only with ads. It should be noted, that commercial databases or otherwise readily available database may be used in addition to or in lieu of spidering.

It should be noted as indices are built from spidering. As such, each word in the index may reference other words by way of a weighted reference. For example, a website with a reference to a car may have a large number of links to other websites with tires, but only a few links to websites dealing with steel. The weights of references may be stored in the index to create a weighted and directed topological index map. These weights may be used to augment searches or provide additional emphasis. For example, if a user is searching for tires and the above noted car web page comes up, it would be emphasized because of its topological relationship to other tire websites over car websites that have fewer references to tire web sites.

As has already been discussed in FIG. 2, query formation 525 takes all the expanded keywords, alternative spellings, etc. and combines them in every possible permutation to create a fully expanded query set expansion 525. Regardless of the target, whether it is a desktop 540 or a database across the network 560, both targets use index data 535, 555 to search against the expanded query set of terms. In the case of a desktop search, the index data is built by scanning, e.g., a local hard drive, for all text documents 530 and indexing all individual words found on the hard drive 535. Thereafter, all the expanded keywords and all permutations thereof are compared against the index and matches are identified as search results 565. Similarly, a centralized file database or an internet database also has a data index set 555. Typically, the internet search facility will have a larger index data set 555 and would be stored across numerous servers. The index data may be generated by spidering across the World Wide Web, FTP, and other internet data stores. By providing various parameter fields 545 for the spider to follow all data links and index all individual words into a discreet data index file. As matches query permutations match entries in the index 535, 555, matching hits are returned as search results 565, which are provided for ranking 570.

Data Ranker

FIG. 6 is of a data and logic flow diagram illustrating embodiments of the present invention detailing a data ranker. Continuing from FIG. 5, the search results 565 are provided 570 for ranking. In conjunction with the data selector, the data ranker allows the AIDSA to super target the increased number of search results. Super-targeting is achieved largely through keyword scoring 620 and other parameter scoring of results from the data selector 615. The query 605 obtains all the results from the query formation module 615 including emphasis requirement 610. Ranking is achieved by way of keyword scoring 620 and other scoring parameters 650. A scoring table 653 is used by the data ranker 695. With regard to the keyword scoring 620, an exact match of keywords or phases in a word order will provide an increased rank 645 to the exact match score. This score is stored into the scoring table for access by the data ranker 695. In one embodiment the scoring table is generated for a particular query 605. This may be achieved by maintaining a session ID that uniquely identifies a query and subsequent responses. In addition to the session ID, a reference to the originating reference is maintained, along with a scoring weights.

| | | Exact | | | | | | |
|---|---|---|---|---|---|---|---|---|
| | | Match | Emphasis | Frequency | Parameter | Freshness | Completeness | Preference |
| SessionID | Reference | Score | Score | Score | Score | Score | Score | Score |
| Abcdef1234 | www.xyz.com/page | 1.0 | 0.3 | 0.3 | 0.5 | 0.8 | 0.4 | 0.5 |

Also, emphasized words or phrases from the query will indicate whether and/or how great an emphasis score is for a particular matched reference 630. For example, if a query emphasizes one of the keywords, then results matching that exact keyword term will have a higher emphasis score and that keyword's expanded related words will have lower emphasis scores. Also, a rank is given based on a frequency ratio 625. The frequency ratio may be expressed as:

$$\frac{( \begin{matrix}number of times a search \\ term appears in a reference document\end{matrix} )}{( total number of words the reference document )}$$

In another embodiment, a basic hits frequency score may be used. A basic hits score increases the more times a word or phase occurs in a matching document or reference source. The frequency score and/or ratio is also provided 640 to the scoring table 693. Other scoring parameters 650 may be included. In one embodiment, a hit density score may be determined by a hit density module 672. For example, a frequency ratio for a single chapter of a book may be high for a given search query, but may be low for the entire book. As such, the chapter with a high occurrence of terms matching a query will provide a higher density score 692 to the scoring table 693.

A parameter score is determined by a a parameter score module 670. For example, if a user specifies a query with parameters that specify the size of a company. In such an example, any results that are returned and fall within the specified parameter range (as determined by a parameter module 670) will have an increased parameter score value 690 as apposed to those falling outside the range. Another scoring value is a freshness score 685 as provided by the freshness scoring module 665. The freshness module assigns higher score values to more current matching references over older matching references. This may be achieved by simply examining the last edit date of a given document or reference.

Next, the completeness score 680 is determined by the completeness scoring module 660. This may be achieved by noting the number of non-null fields exist in the database 660. For example, if two results are returned each having company contact information for Acme Pizza, where one reference has name, address, and telephone number values and a second reference has only name and telephone number values, than the first reference will be more complete and thereby provide a higher completeness score 680 into the scoring table 693. As such, the more null fields that exist in a given reference target and/or database, the less complete that database record is, and the less complete the search results will be. Thus, in such a scenario, the completeness score 680 would be lower. Finally there is a preference score 675 as determined by a preference score module 655. All of the scores 692, 690, 685, 680, 675 are provided to the scoring table 693. The preference score may be arbitrarily assigned to various search result references. For example, a preference may be given to sponsor keywords where an advertiser may pay to increase the result of a ranking score 675. In such a scenario, if two references contain words matching the query, the preference scoring module may provide a higher preference score 675 to one of the references where the advertiser paid for the increased ranking.

After all the scores 645, 640, 692, 690, 685, 680, 675 are provided to the scoring table 693, they may be summed and then the data ranker may rank each of the matching references based on their total ranking score. In one embodiment, the data ranker 695 ranks the references from highest down to lowest and shows the user the results with the highest rankings 697. In another embodiment, the data ranker may sort by the uniqueness of a result. If a particular result has a great many number of other identified references that point to that particular result, it is said to have a “high gravity” and its uniqueness as high quality source is judged to be higher. In such an embodiment, the AIDSA checks the number of links that refer to the particular result, and results with more references, i.e., greater gravity, are given higher rankings.

FIG. 7 is of a block diagram illustrating embodiments of related words generation and AIDSA result rankings. Here an example search query is provided by way of keywords “business” 705, “process” 710, “management” 715, “software” 720 and “application” 725. This query results in a related words tree structure as illustrated. Related words are identified by the AIDSA for the words “business” 730, “process” 735, “management” 740, “software” 745 and “application” 750. In addition related word phrases are generated for the word phrases “business process” 727 and “process management” 729. The related words are identified as has already been discussed in previous figures. Thereafter, permutations of keywords and related words are searched across a database and/or database reference index and several reference documents are returned 751-758. Excerpts from each of the documents are provided in the figure whereby words in bold match keywords and/or keyword phrases, words in italics match related words, and words in bold italic match related word phrases. In this example set of results, we see the highest ranked results are provided by reference 758, which has a related phrase “business activity” and the exact word phrase “business process management” 705, 710, 715 repeat several times within the body of the reference document 758. The next highest ranked result is reference 751, which has the exact word phrase “business process management” 705, 710, 715 repeat several times within the body of the reference document 751, but does not have the additional related phrase instance found in reference 758. The next highest ranked reference result 752 has the exact keyword phrase “business process management,” but it occurs with lesser frequency than reference 751. The next highest ranked result, reference 753, has a matching word phrase “business process” 705, 710 and then intervening text before another keyword term, “management,” is found within the reference 753; as such this reference is ranked beneath reference 752, which preserves word order and proximity. The next highest ranked result is reference 754, which has related word matches of “business activity” 727 and “line management” in addition to keyword matches of the words “process” 710 and “management” 715. The next highest ranked result is reference 755, which matches keywords “process” 710, “management” 715 and “business” 705 out of order and with intervening text. As such, reference 754 has a higher ranking here as the two matching related word phrases “business activity” 727 and “line management” 729 provide a greater total score than a single keyword “business” in reference 755. Reference 756 is ranked lower still as it contains only a single keyword match. And reference 757 is ranked last as it contains only a single related word 730 “concern.” It should be noted that this is an example ranking profile and that many ranking profiles may be established to better tailor various deployment requirements and/or to better tailor results for specific kinds of searches.

Artificial Intelligence for Data Searching Applications Controller

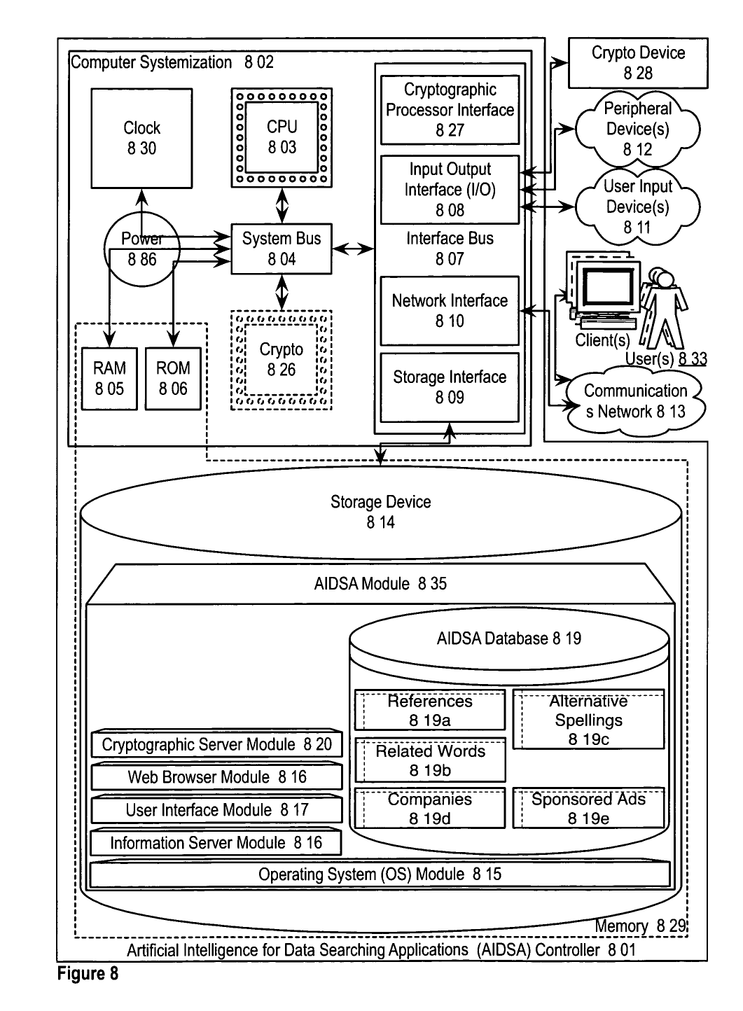

FIG. 8 is of a block diagram illustrating embodiments of a Artificial Intelligence for Data Searching Applications (AIDSA) controller 801. In this embodiment, the AIDSA controller 801 may serve to process, store, search, serve, identify, instruct, generate, match, and/or update data records, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the AIDSA controller 801 may be connected to and/or communicate with entities such as, but not limited to: one or more users from user input devices 811; peripheral devices 812; a cryptographic processor device 828; and/or a communications network 813.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

An AIDSA controller 801 may be based on common computer systems that may comprise, but are not limited to, components such as: a computer systemization 802 connected to memory 829.

Computer Systemization

A computer systemization 802 may comprise a clock 830, central processing unit (CPU) 803, a read only memory (ROM) 806, a random access memory (RAM) 805, and/or an interface bus 807, and most frequently, although not necessarily, are all interconnected and/or communicating through a system bus 804. Optionally, the computer systemization may be connected to an internal power source 886. Optionally, a cryptographic processor 826 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the AIDSA controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 886 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the AIDSA thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a/b; infrared; joystick; keyboard; midi; optical; PC AT, PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 811 may be card readers, dongles, finger print readers, gloves, graphics tablets, joysticks, keyboards, mouse (mice), remote controls, retina readers, trackballs, trackpads, and/or the like.

Peripheral devices 812 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the AIDSA controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the AIDSA controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that a AIDSA controller and/or a computer systemization may employ various forms of memory 829. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 829 may contain a collection of program and/or database modules and/or data such as, but not limited to: operating system module(s) 815 (operating system); information server module(s) 816 (information server); user interface module(s) 817 (user interface); Web browser module(s) 818 (Web browser); database(s) 819; cryptographic server module(s) 820 (cryptographic server); AIDSA module(s) 835; and/or the like (i.e., collectively a module collection). These modules may be stored and accessed from the storage devices and/or from storage devices accessible through an interface bus. Although non-conventional software modules such as those in the module collection, typically, are stored in a local storage device 814, they may also be loaded and/or stored in memory such as: peripheral devices, RAM, remote storage facilities through a communications network, ROM, various forms of memory, and/or the like.

Operating System

The operating system module 815 is executable program code facilitating the operation of a AIDSA controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the AIDSA controller to communicate with other entities through a communications network 813. Various communication protocols may be used by the AIDSA controller as a subcarrier transport mechanism for interaction, such as, but not limited to: multicast, TCP/IP, UDP, unicast, and/or the like.

Information Server

An information server module 816 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP) HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on a AIDSA controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the AIDSA database 819, operating systems, other program modules, user interfaces, Web browsers, and/or the like.

Access to the AIDSA database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the AIDSA. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the AIDSA as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 817 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 818 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from AIDSA enabled nodes. The combined application may be nugatory on systems employing standard Web browsers.

Cryptographic Server

A cryptographic server module 820 is stored program code that is executed by the CPU 803, cryptographic processor 826, cryptographic processor interface 827, cryptographic processor device 828, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the AIDSA may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable a AIDSA module to engage in secure transactions if so desired. The cryptographic module facilitates the secure accessing of resources on AIDSA and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

AIDSA Database

An AIDSA database module 819 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the AIDSA database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the AIDSA database is implemented as a data-structure, the use of the AIDSA database 819 may be integrated into another module such as the AIDSA module 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 819 includes several tables 819a-e. A references table 819a includes fields such as, but not limited to: keywords, any media, datastructure, datatype, reference address, and/or the like. The references table hold various keywords built from the indexing of data. A related words table 819b includes fields such as, but not limited to: keywords, synonyms, antonyms, related words, root words, related words address, any media, datastructure, datatype, and/or the like. In on embodiment, the related words table 319b may be the WordNet dictionary. An alternative words table 819c includes fields such as, but not limited to: keywords, related words, root words, alternative spellings, misspellings, and/or the like. A companies table 819d includes fields such as, but not limited to: company name, address, URL, phone number, any media, datastructure, datatype, reference address, and/or the like. A sponsored advertising table 819e includes fields such as, but not limited to: company name, address, phone number, account number, payments, ads, any media, datastructure, datatype, reference address, and/or the like.

In one embodiment, the AIDSA database may interact with other database systems. For example, employing a distributed database system, queries and data access by AIDSA modules may treat the combination of the AIDSA database, and the AIDSA as a single database entity.

In one embodiment, user programs may contain various user interface primitives, which may serve to update the AIDSA. Also, various accounts may require custom database tables depending upon the environments and the types of clients a AIDSA may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database modules 819a-j. The AIDSA may be configured to keep track of various settings, inputs, and parameters via database controllers.

A AIDSA database may communicate to and/or with other modules in a module collection, including itself, and/or facilities of the like. Most frequently, the AIDSA database communicates with a AIDSA module, other program modules, and/or the like. The database may contain, retain, and provide information regarding other nodes and data.

AIDSA

A AIDSA module 835 is stored program code that is executed by the CPU. The AIDSA affects accessing, obtaining and the provision of information, services, transactions, and/or the like across various communications networks.

The AIDSA enables searchers to better target their searches and yield better search results by intelligently providing synonyms of keywords. The AIDSA coordinates with the AIDSA database to identify interassociated items relating to data, and/or any related transactions and acts upon any provided information.

A AIDSA module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the AIDSA server employs a cryptographic server to encrypt and decrypt communications. A AIDSA module may communicate to and/or with other modules in a module collection, including itself, and/or facilities of the like. Most frequently, the AIDSA module communicates with a AIDSA database, operating systems, other program modules, and/or the like. The AIDSA may contain, communicate, generate, obtain, and/or provide program module, system, user, and/or data communications, requests, and/or responses.

Distributed AIDSA

The structure and/or operation of any of the AIDSA node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the AIDSA controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, claims, Abstract, Figures, and otherwise) shows by way of illustration various embodiments in which the inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1. A processor-enabled method to search data, comprising:
obtaining a query from a user; wherein the query's terms may include keywords, conjunctions, query parameters and query emphasis;
identifying terms within the query that are misspelled,
wherein the query terms are compared against a dictionary,
wherein the dictionary is a dictionary of interassociated words;
determining a correct word spelling for the misspelled word and using the correctly spelled word as a query term;
matching terms within the query to words in the dictionary of interassociated words;
identifying partial words related to the matching terms in the interassociated words dictionary,
wherein partial words are identified by determining word roots of query terms;
identifying alternative word spellings related to the query terms in a dictionary,
wherein the identified alternative spellings are used in addition to the query terms,
wherein the identified alternative spellings include common misspellings;
identifying words related to the matched terms in the interassociated words dictionary;
determining if pluralities of the query terms constitute word phrases,
wherein a query term's word order within the query may be used to determine if a plurality of the matched terms constitute a word phrase,
wherein a query term's proximity to other query terms may be used to determine if a plurality of the matched terms constitute a word phrase,
wherein a query term's word order within the query establishes its grammatical type;
generating an expanded query including identified related words,
wherein the identified related words further include partial words and alternative spellings,
wherein the expanded query includes all permutations of query terms and related words,
wherein query parameters are used to alter an expanded query's makeup;
searching memory with the expanded query for matching references, wherein the memory includes a database index;
ranking matching references, wherein the factors may affect the rankings of references include:
references with a greater incidence of matching terms from the expanded query are given higher rankings,
references with a greater ratio of matching terms from the expanded query as compared to the references total number of words are given higher rankings,
references with matching terms that are emphasized from the expanded query are given higher rankings than references with non-emphasized matching terms from the expanded query,
references that more exactly match query terms from the expanded query are ranked higher,
references falling within query parameters are ranked higher,
more recent references are ranked higher than older references,
sponsored references are ranked higher, and
references that more completely satisfy the obtained query are ranked higher; and
providing ranked matching references in response to the user for display, wherein the rankings are affected by emphasis of the query terms and emphasis of words related to the query terms, wherein the emphasis value of the related query terms is related to the emphasis value of the query terms.

2. In memory, an interaction interface invokeable by an application program responsive to user selections to invoke application module commands, comprising:
an information bar to display super-targeted search results generated from an expanded query that includes related query words.

3. The method of claim 2, wherein the information bar limits the display of super-targeted search results based on metadata contained at the reference location.

4. The method of claim 2, wherein the information bar limits the display of super-targeted search results based on metadata controlled by the information bar.

5. The method of claim 2, wherein the information bar provides a facility to view comparable goods and services to those being viewed at a currently viewed web site.

6. In memory, an interaction interface invokeable by an application program responsive to user selections to invoke application module commands, comprising:
an emphasis user interface responsive to a user's highlight of a keywords to establish a level of emphasis for the highlighted words.

7. The interaction interface of claim 2, wherein the responsive user interface is a slider widget.

8. The interaction interface of claim 2, wherein the responsive user interface is a radio button.

9. The interaction interface of claim 2, wherein the responsive user interface is a check box.

10. A processor-enabled method to search data, comprising:
obtaining a query;
matching terms within the query to words in a dictionary;
identifying words related to the matched terms in the dictionary;
generating an expanded query including identified related words;
searching memory with the expanded query for matching references;
ranking matching references, wherein ranking employs super-targeting; and
providing ranked matching references in response to the obtained query.

11. The method of claim 10, wherein the dictionary is a dictionary of interassociated words.

12. A processor-enabled method to search data, comprising:
obtaining a query;
matching terms within the query to words in a dictionary of interassociated words;
identifying words related to the matched terms in the interassociated words dictionary;
generating an expanded query including identified related words;
searching memory with the expanded query for matching references;
ranking matching references; and
providing ranked matching references in response to the obtained query.

13. The method of claim 12, wherein the related words are identified by a user making a selection of a subset of related words identified from the interassociated words dictionary.

14. The method of claim 12, wherein the query is obtained through voice recognition.

15. The method of claim 14, wherein the memory being search contains commands that may be executed.

16. The method of claim 12, wherein a ranking is based on higher scores.

17. The method of claim 12, wherein a ranking is based on lower scores.

18. The method of claim 12, wherein a ranking is based on gravity.

19. The method of claim 12, wherein a ranking is based on uniqueness.

20. The method of claim 14, wherein a highest ranked matching reference is selected as a command for execution.

21. The method of claim 12, wherein the query is obtained from a searcher.

22. The method of claim 12, wherein the query's terms include keywords.

23. The method of claim 12, wherein the query's terms include parameters.

24. The method of claim 12, wherein the query's terms include emphasis.

25. The method of claim 24, wherein the identified related words of the matching terms have an emphasis value related to the emphasis value of the matching terms.

26. The method of claim 25, wherein the related emphasis value is the same as the matching terms.

27. The method of claim 25, wherein the related emphasis value decays in value from the emphasis value of the matching terms.

28. The method of claim 24, wherein an emphasis value is supplied via a user interface.

29. The method of claim 28, wherein the emphasis value is continuously re-supplied as a user manipulates the user interface and thereby causes provision of re-ranked references.

30. The method of claim 12, wherein the query's terms include conjunctions.

31. The method of claim 30, wherein the conjunctions are Boolean operators.

32. The method of claim 12, further, comprising:
identifying terms within the query that are misspelled.

33. The method of claim 32, wherein the query terms are compared against a dictionary.

34. The method of claim 33, wherein the dictionary is a dictionary of interassociated words.

35. The method of claim 33, further, comprising:
determining a correct word spelling for the misspelled word and using the correctly spelled word as a query term.

36. The method of claim 35, wherein the correctly spelled word replaces the misspelled word in the query.

37. The method of claim 35, wherein the correctly spelled word is used in addition to the misspelled word in the query.

38. The method of claim 12, further, comprising:
identifying words having phonetic similarities to the matching terms in the interassociated words dictionary.

39. The method of claim 12, further, comprising:
identifying partial words related to the matching terms in the interassociated words dictionary.

40. The method of claim 39, wherein partial related words are identified by determining word roots of query terms.

41. The method of claim 39, further, comprising:
identifying related words for partial words.

42. The method of claim 12, further, comprising:
identifying alternative word spellings related to the query terms in a dictionary.

43. The method of claim 42, wherein the alternative word spelling is a misspelling.

44. The method of claim 42, wherein the dictionary is an interassociated words dictionary that is used for identifying alternative spellings.

45. The method of claim 42, wherein the dictionary is a dictionary of misspellings.

46. The method of claim 45, wherein common misspellings are related to correct spellings in the dictionary of misspellings.

47. The method of claim 45, wherein the identified word misspellings are used in addition to the query terms.

48. The method of claim 47, wherein the word misspellings that are used are common misspellings.

49. The method of claim 12, further, comprising:
determining if pluralities of the query terms constitute word phrases.

50. The method of claim 49, wherein a query term's word order within the query is used to determine if a plurality of the matched terms constitute a word phrase.

51. The method of claim 49, wherein a query term's proximity to other query terms is used to determine if a plurality of the matched terms constitute a word phrase.

52. The method of claim 49, wherein a query term's word order within the query establishes its grammatical type.

53. The method of claim 52, wherein a query term's grammatical type within the query is used to emphasize query terms.

54. The method of claim 52, wherein a query term's grammatical type is used to select related words of a same grammatical type from the dictionary.

55. The method of claim 12, wherein a query term's word order within the query is used to emphasize query terms.

56. The method of claim 12, wherein a query term's grammatical type within the query is used to emphasize query terms.

57. The method of claim 12, further, comprising:
identifying related words for alternative word spellings.

58. The method of claim 12, further, comprising:
identifying additional related words for emphasized query terms.

59. The method of claim 58, wherein the additional related words are identified by recursively identifying words related to previously identified related words.

60. The method of claim 12, wherein the identified related words further include identified partial words.

61. The method of claim 12, wherein the identified related words further include equivalent words from languages other than a language used in the obtained query.

62. The method of claim 61, wherein language translation dictionaries are used to translate the obtained query from one language to another and foreign dictionaries of interassociated words are used to match and identify related words for any translated query terms.

63. The method of claim 61, wherein parameters allow users to specify languages in which they want a resulting expanded search to be generated.

64. The method of claim 12, wherein the identified related words further include alternative spellings.

65. The method of claim 64, wherein alternative spellings are misspellings.

66. The method of claim 12, wherein the expanded query includes all permutations of query terms and related words.

67. The method of claim 12, wherein the expanded query includes all permutations of related words and no query terms.

68. The method of claim 12, wherein the expanded query includes all permutations of query terms and no related words.

69. The method of claim 12, wherein query parameters are used to alter an expanded query's makeup.

70. The method of claim 69, wherein the alteration limits how many related words are to be used for an expanded query.

71. The method of claim 70, wherein more common words are used when selecting a limited number of related words from a larger set of identified related words.

72. The method of claim 71, wherein the memory includes a database.

73. The method of claim 71, wherein the memory includes an index.

74. The method of claim 71, wherein the memory is on a remote system.

75. The method of claim 71, wherein the memory is distributed across multiple systems.

76. The method of claim 12, wherein references with a greater incidence of matching terms from the expanded query are given higher rankings.

77. The method of claim 12, wherein references with a greater ratio of matching terms from the expanded query as compared to the references' total number of words are given higher rankings.

78. The method of claim 12, wherein references with matching terms that are emphasized from the expanded query are given higher rankings than references with non-emphasized matching terms from the expanded query.

79. The method of claim 78, wherein the identified related words of the matching terms in the expanded query have an emphasis value related to the emphasis value of the matching terms.

80. The method of claim 79, wherein the related emphasis value is the same as the matching terms.

81. The method of claim 79, wherein the related emphasis value decays in value from the emphasis value of the matching terms.

82. The method of claim 12, wherein references falling within query parameters are ranked higher.

83. The method of claim 12, wherein more recent references are ranked higher than older references.

84. The method of claim 12, wherein sponsored references are ranked higher.

85. The method of claim 12, wherein references that more completely satisfy the obtained query are ranked higher.

86. The method of claim 12, wherein references that with higher hit density are ranked higher.

87. The method of claim 12, wherein references that more exactly match query terms from the expanded query are ranked higher.

88. The method of claim 87, wherein more exact matches are characterized by having a word order like the obtained query.

89. The method of claim 87, wherein more exact matches are characterized by maintaining similar word proximities as between the obtained query.

90. The method of claim 12, further, comprising:
displaying the ranked matching references.

91. A processor-enabled method to provide relevant data, comprising:
copying words from a web page at a location;
generating a query from unique words from the web page;
matching terms within the query to words in a dictionary of interassociated words;
identifying words related to the matched terms in the interassociated words dictionary;
generating an expanded query including identified related words;
searching memory with the expanded query for matching references;
ranking matching references; and
providing ranked matching references in response to the obtained query;
displaying the ranked references in an information bar in the web browser.

92. The method of claim 91, wherein duplicate words add emphasis to the unique words constituting the query.

93. A processor-enabled method to advertise relevant data, comprising:
copying words from a web page at a location;
generating a query from unique words from the web page;
matching terms within the query to words in a dictionary of interassociated words;
identifying words related to the matched terms in the interassociated words dictionary;
generating an expanded query including identified related words;
searching memory with the expanded query for matching references, wherein the memory includes a database of advertisements;
ranking matching references; and
providing ranked matching references in response to the obtained query;
displaying the ranked references in an advertisement.

94. The method of claim 93, wherein the related words are identified by a user making a selection of a subset of related words identified from the interassociated words dictionary.

95. The method of claim 93, wherein the query's terms include keywords.

96. The method of claim 93, wherein the query's terms include parameters and wherein parameters are specified by constraints provided by the advertiser.

97. The method of claim 93, wherein the query's terms include emphasis.

98. The method of claim 97, wherein the identified related words of the matching terms have an emphasis value related to the emphasis value of the matching terms.

99. The method of claim 98, wherein the related emphasis value is the same as the matching terms.

100. The method of claim 98, wherein the related emphasis value decays in value from the emphasis value of the matching terms.

101. The method of claim 93, wherein the query's terms include conjunctions.

102. The method of claim 101, wherein the conjunctions are Boolean operators.

103. The method of claim 93, further, comprising:
identifying terms within the query that are misspelled.

104. The method of claim 103, wherein the query terms are compared against a dictionary.

105. The method of claim 104, wherein the dictionary is a dictionary of interassociated words.

106. The method of claim 104, further, comprising:
determining a correct word spelling for the misspelled word and using the correctly spelled word as a query term.

107. The method of claim 106, wherein the correctly spelled word replaces the misspelled word in the query.

108. The method of claim 106, wherein the correctly spelled word is used in addition to the misspelled word in the query.

109. The method of claim 93, further, comprising:
identifying words having phonetic similarities to the matching terms in the interassociated words dictionary.

110. The method of claim 93, further, comprising:
identifying partial words related to the matching terms in the interassociated words dictionary.

111. The method of claim 110, wherein partial related words are identified by determining word roots of query terms.

112. The method of claim 110, further, comprising:
identifying related words for partial words.

113. The method of claim 93, further, comprising:
identifying alternative word spellings related to the query terms in a dictionary.

114. The method of claim 113, wherein the alternative word spelling is a misspelling.

115. The method of claim 113, wherein the dictionary is an interassociated words dictionary that is used for identifying alternative spellings.

116. The method of claim 113, wherein the dictionary is a dictionary of misspellings.

117. The method of claim 116, wherein common misspellings are related to correct spellings in the dictionary of misspellings.

118. The method of claim 116, wherein the identified word misspellings are used in addition to the query terms.

119. The method of claim 118, wherein the word misspellings that are used are common misspellings.

120. The method of claim 93, further, comprising:
determining if pluralities of the query terms constitute word phrases.

121. The method of claim 120, wherein a query term's word order within the query is used to determine if a plurality of the matched terms constitute a word phrase.

122. The method of claim 120, wherein a query term's proximity to other query terms is used to determine if a plurality of the matched terms constitute a word phrase.

123. The method of claim 120, wherein a query term's word order within the query establishes its grammatical type.

124. The method of claim 123, wherein a query term's grammatical type within the query is used to emphasize query terms.

125. The method of claim 123, wherein a query term's grammatical type is used to select related words of a same grammatical type from the dictionary.

126. The method of claim 93, wherein a query term's word order within the query is used to emphasize query terms.

127. The method of claim 93, wherein a query term's grammatical type within the query is used to emphasize query terms.

128. The method of claim 93, further, comprising:
identifying related words for alternative word spellings.

129. The method of claim 93, further, comprising:
identifying additional related words for emphasized query terms.

130. The method of claim 129, wherein the additional related words are identified by recursively identifying words related to previously identified related words.

131. The method of claim 93, wherein the identified related words further include identified partial words.

132. The method of claim 93, wherein the identified related words further include equivalent words from languages other than a language used in the generated query.

133. The method of claim 132, wherein language translation dictionaries are used to translate the generated query from one language to another and foreign dictionaries of interassociated words are used to match and identify related words for any translated query terms.

134. The method of claim 132, wherein parameters allow users to specify languages in which they want a resulting expanded search to be generated.

135. The method of claim 93, wherein the identified related words further include alternative spellings.

136. The method of claim 135, wherein alternative spellings are misspellings.

137. The method of claim 93, wherein the expanded query includes all permutations of query terms and related words.

138. The method of claim 93, wherein the expanded query includes all permutations of related words and no query terms.

139. The method of claim 93, wherein the expanded query includes all permutations of query terms and no related words.

140. The method of claim 93, wherein query parameters are used to alter an expanded query's makeup.

141. The method of claim 140, wherein the alteration limits how many related words are to be used for an expanded query.

142. The method of claim 141, wherein more common words are used when selecting a limited number of related words from a larger set of identified related words.

143. The method of claim 142, wherein the memory includes a database.

144. The method of claim 142, wherein the memory includes an index.

145. The method of claim 142, wherein the memory is on a remote system.

146. The method of claim 142, wherein the memory is distributed across multiple systems.

147. The method of claim 93, wherein references with a greater incidence of matching terms from the expanded query are given higher rankings.

148. The method of claim 93, wherein references with a greater ratio of matching terms from the expanded query as compared to the references' total number of words are given higher rankings.

149. The method of claim 93, wherein references with matching terms that are emphasized from the expanded query are given higher rankings than references with non-emphasized matching terms from the expanded query.

150. The method of claim 149, wherein the identified related words of the matching terms in the expanded query have an emphasis value related to the emphasis value of the matching terms.

151. The method of claim 150, wherein the related emphasis value is the same as the matching terms.

152. The method of claim 150, wherein the related emphasis value decays in value from the emphasis value of the matching terms.

153. The method of claim 93, wherein references falling within query parameters are ranked higher.

154. The method of claim 93, wherein more recent references are ranked higher than older references.

155. The method of claim 93, wherein sponsored references are ranked higher.

156. The method of claim 93, wherein references that more completely satisfy the generated query are ranked higher.

157. The method of claim 93, wherein references that more exactly match query terms from the expanded query are ranked higher.

158. The method of claim 157, wherein more exact matches are characterized by having a word order like the generated query.

159. The method of claim 157, wherein more exact matches are characterized by maintaining similar word proximities as between the generated query.

160. The method of claim 93, further, comprising:
displaying the ranked matching references.

161. A system to search data, comprising:
means to obtain a query;
means to match terms within the query to words in a dictionary;
means to identify words related to the matched terms in the dictionary;
means to generate an expanded query including identified related words;
means to search memory with the expanded query for matching references;
means to rank matching references, wherein ranking employs super-targeting; and
means to provide ranked matching references in response to the obtained query.

162. The system of claim 161, wherein the dictionary is a dictionary of interassociated words.

163. A system to search data, comprising:
means to obtain a query;
means to match terms within the query to words in a dictionary of interassociated words;
means to identify words related to the matched terms in the interassociated words dictionary;
means to generate an expanded query including identified related words;
means to search memory with the expanded query for matching references;
means to rank matching references; and
means to provide ranked matching references in response to the obtained query.

164. The system of claim 163, wherein the related words are identified by a user making a selection of a subset of related words identified from the interassociated words dictionary.

165. The system of claim 163, wherein the query is obtained through voice recognition.

166. The system of claim 165, wherein the memory being search contains commands that may be executed.

167. The system of claim 163, wherein a ranking is based on higher scores.

168. The system of claim 163, wherein a ranking is based on lower scores.

169. The system of claim 163, wherein a ranking is based on gravity.

170. The system of claim 163, wherein a ranking is based on uniqueness.

171. The system of claim 165, wherein a highest ranked matching reference is selected as a command for execution.

172. The system of claim 163, wherein the query is obtained from a searcher.

173. The system of claim 163, wherein the query's terms include keywords.

174. The system of claim 163, wherein the query's terms include parameters.

175. The system of claim 163, wherein the query's terms include emphasis.

176. The system of claim 175, wherein the identified related words of the matching terms have an emphasis value related to the emphasis value of the matching terms.

177. The system of claim 176, wherein the related emphasis value is the same as the matching terms.

178. The system of claim 176, wherein the related emphasis value decays in value from the emphasis value of the matching terms.

179. The system of claim 175, wherein an emphasis value is supplied via a user interface.

180. The system of claim 179, wherein the emphasis value is continuously re-supplied as a user manipulates the user interface and thereby causes provision of re-ranked references.

181. The system of claim 163, wherein the query's terms include conjunctions.

182. The system of claim 181, wherein the conjunctions are Boolean operators.

183. The system of claim 163, further, comprising:
means to identify terms within the query that are misspelled.

184. The system of claim 183, wherein the query terms are compared against a dictionary.

185. The system of claim 184, wherein the dictionary is a dictionary of interassociated words.

186. The system of claim 184, further, comprising:
means to determine a correct word spelling for the misspelled word and using the correctly spelled word as a query term.

187. The system of claim 186, wherein the correctly spelled word replaces the misspelled word in the query.

188. The system of claim 186, wherein the correctly spelled word is used in addition to the misspelled word in the query.

189. The system of claim 163, further, comprising:
means to identify words having phonetic similarities to the matching terms in the interassociated words dictionary.

190. The system of claim 163, further, comprising:
means to identify partial words related to the matching terms in the interassociated words dictionary.

191. The system of claim 190, wherein partial related words are identified by determining word roots of query terms.

192. The system of claim 190, further, comprising:
means to identify related words for partial words.

193. The system of claim 163, further, comprising:
means to identify alternative word spellings related to the query terms in a dictionary.

194. The system of claim 193, wherein the alternative word spelling is a misspelling.

195. The system of claim 193, wherein the dictionary is an interassociated words dictionary that is used for identifying alternative spellings.

196. The system of claim 193, wherein the dictionary is a dictionary of misspellings.

197. The system of claim 196, wherein common misspellings are related to correct spellings in the dictionary of misspellings.

198. The system of claim 196, wherein the identified word misspellings are used in addition to the query terms.

199. The system of claim 198, wherein the word misspellings that are used are common misspellings.

200. The system of claim 163, further, comprising:
means to determine if pluralities of the query terms constitute word phrases.

201. The system of claim 200, wherein a query term's word order within the query is used to determine if a plurality of the matched terms constitute a word phrase.

202. The system of claim 200, wherein a query term's proximity to other query terms is used to determine if a plurality of the matched terms constitute a word phrase.

203. The system of claim 200, wherein a query term's word order within the query establishes its grammatical type.

204. The system of claim 203, wherein a query term's grammatical type within the query is used to emphasize query terms.

205. The system of claim 203, wherein a query term's grammatical type is used to select related words of a same grammatical type from the dictionary.

206. The system of claim 163, wherein a query term's word order within the query is used to emphasize query terms.

207. The system of claim 163, wherein a query term's grammatical type within the query is used to emphasize query terms.

208. The system of claim 163, further, comprising:
means to identify related words for alternative word spellings.

209. The system of claim 163, further, comprising:
means to identify additional related words for emphasized query terms.

210. The system of claim 209, wherein the additional related words are identified by recursively identifying words related to previously identified related words.

211. The system of claim 163, wherein the identified related words further include identified partial words.

212. The system of claim 163, wherein the identified related words further include equivalent words from languages other than a language used in the obtained query.

213. The system of claim 212, wherein language translation dictionaries are used to translate the obtained query from one language to another and foreign dictionaries of interassociated words are used to match and identify related words for any translated query terms.

214. The system of claim 212, wherein parameters allow users to specify languages in which they want a resulting expanded search to be generated.

215. The system of claim 163, wherein the identified related words further include alternative spellings.

216. The system of claim 215, wherein alternative spellings are misspellings.

217. The system of claim 163, wherein the expanded query includes all permutations of query terms and related words.

218. The system of claim 163, wherein the expanded query includes all permutations of related words and no query terms.

219. The system of claim 163, wherein the expanded query includes all permutations of query terms and no related words.

220. The system of claim 163, wherein query parameters are used to alter an expanded query's makeup.

221. The system of claim 220, wherein the alteration limits how many related words are to be used for an expanded query.

222. The system of claim 221, wherein more common words are used when selecting a limited number of related words from a larger set of identified related words.

223. The system of claim 222, wherein the memory includes a database.

224. The system of claim 222, wherein the memory includes an index.

225. The system of claim 222, wherein the memory is on a remote system.

226. The system of claim 222, wherein the memory is distributed across multiple systems.

227. The system of claim 163, wherein references with a greater incidence of matching terms from the expanded query are given higher rankings.

228. The system of claim 163, wherein references with a greater ratio of matching terms from the expanded query as compared to the references' total number of words are given higher rankings.

229. The system of claim 163, wherein references with matching terms that are emphasized from the expanded query are given higher rankings than references with non-emphasized matching terms from the expanded query.

230. The system of claim 229, wherein the identified related words of the matching terms in the expanded query have an emphasis value related to the emphasis value of the matching terms.

231. The system of claim 230, wherein the related emphasis value is the same as the matching terms.

232. The system of claim 230, wherein the related emphasis value decays in value from the emphasis value of the matching terms.

233. The system of claim 163, wherein references falling within query parameters are ranked higher.

234. The system of claim 163, wherein more recent references are ranked higher than older references.

235. The system of claim 163, wherein sponsored references are ranked higher.

236. The system of claim 163, wherein references that more completely satisfy the obtained query are ranked higher.

237. The system of claim 163, wherein references that with higher hit density are ranked higher.

238. The system of claim 163, wherein references that more exactly match query terms from the expanded query are ranked higher.

239. The system of claim 238, wherein more exact matches are characterized by having a word order like the obtained query.

240. The system of claim 238, wherein more exact matches are characterized by maintaining similar word proximities as between the obtained query.

241. The system of claim 163, further, comprising:
displaying the ranked matching references.

242. A system to provide relevant data, comprising:
means to copy words from a web page at a location;
means to generate a query from unique words from the web page;
means to match terms within the query to words in a dictionary of interassociated words;
means to identify words related to the matched terms in the interassociated words dictionary;
means to generate an expanded query including identified related words;
means to search memory with the expanded query for matching references;
means to rank matching references; and
means to provide ranked matching references in response to the obtained query;
means to display the ranked references in an information bar in the web browser.

243. The system of claim 242, wherein duplicate words add emphasis to the unique words constituting the query.

244. A system to advertise relevant data, comprising:
means to copy words from a web page at a location;
means to generate a query from unique words from the web page;
means to match terms within the query to words in a dictionary of interassociated words;
means to identify words related to the matched terms in the interassociated words dictionary;
means to generate an expanded query including identified related words;
means to search memory with the expanded query for matching references, wherein the memory includes a database of advertisements;
means to rank matching references; and
means to provid ranked matching references in response to the obtained query;
means to display the ranked references in an advertisement.

245. The system of claim 244, wherein the related words are identified by a user making a selection of a subset of related words identified from the interassociated words dictionary.

246. The system of claim 244, wherein the query's terms include keywords.

247. The system of claim 244, wherein the query's terms include parameters and wherein parameters are specified by constraints provided by the advertiser.

248. The system of claim 244, wherein the query's terms include emphasis.

249. The system of claim 248, wherein the identified related words of the matching terms have an emphasis value related to the emphasis value of the matching terms.

250. The system of claim 249, wherein the related emphasis value is the same as the matching terms.

251. The system of claim 249, wherein the related emphasis value decays in value from the emphasis value of the matching terms.

252. The system of claim 244, wherein the query's terms include conjunctions.

253. The system of claim 252, wherein the conjunctions are Boolean operators.

254. The system of claim 244, further, comprising:
means to identify terms within the query that are misspelled.

255. The system of claim 254, wherein the query terms are compared against a dictionary.

256. The system of claim 255, wherein the dictionary is a dictionary of interassociated words.

257. The system of claim 255, further, comprising:
means to determine a correct word spelling for the misspelled word and using the correctly spelled word as a query term.

258. The system of claim 257, wherein the correctly spelled word replaces the misspelled word in the query.

259. The system of claim 257, wherein the correctly spelled word is used in addition to the misspelled word in the query.

260. The system of claim 244, further, comprising:
means to identify words having phonetic similarities to the matching terms in the interassociated words dictionary.

261. The system of claim 244, further, comprising:
means to identify partial words related to the matching terms in the interassociated words dictionary.

262. The system of claim 261, wherein partial related words are identified by determining word roots of query terms.

263. The system of claim 261, further, comprising:
means to identify related words for partial words.

264. The system of claim 244, further, comprising:
means to identify alternative word spellings related to the query terms in a dictionary.

265. The system of claim 264, wherein the alternative word spelling is a misspelling.

266. The system of claim 264, wherein the dictionary is an interassociated words dictionary that is used for identifying alternative spellings.

267. The system of claim 264, wherein the dictionary is a dictionary of misspellings.

268. The system of claim 267, wherein common misspellings are related to correct spellings in the dictionary of misspellings.

269. The system of claim 267, wherein the identified word misspellings are used in addition to the query terms.

270. The system of claim 269, wherein the word misspellings that are used are common misspellings.

271. The system of claim 244, further, comprising:
means to determine if pluralities of the query terms constitute word phrases.

272. The system of claim 271, wherein a query term's word order within the query is used to determine if a plurality of the matched terms constitute a word phrase.

273. The system of claim 271, wherein a query term's proximity to other query terms is used to determine if a plurality of the matched terms constitute a word phrase.

274. The system of claim 271, wherein a query term's word order within the query establishes its grammatical type.

275. The system of claim 274, wherein a query term's grammatical type within the query is used to emphasize query terms.

276. The system of claim 274, wherein a query term's grammatical type is used to select related words of a same grammatical type from the dictionary.

277. The system of claim 244, wherein a query term's word order within the query is used to emphasize query terms.

278. The system of claim 244, wherein a query term's grammatical type within the query is used to emphasize query terms.

279. The system of claim 244, further, comprising:
means to identify related words for alternative word spellings.

280. The system of claim 244, further, comprising:
means to identify additional related words for emphasized query terms.

281. The system of claim 280, wherein the additional related words are identified by recursively identifying words related to previously identified related words.

282. The system of claim 244, wherein the identified related words further include identified partial words.

283. The system of claim 244, wherein the identified related words further include equivalent words from languages other than a language used in the generated query.

284. The system of claim 283, wherein language translation dictionaries are used to translate the generated query from one language to another and foreign dictionaries of interassociated words are used to match and identify related words for any translated query terms.

285. The system of claim 283, wherein parameters allow users to specify languages in which they want a resulting expanded search to be generated.

286. The system of claim 244, wherein the identified related words further include alternative spellings.

287. The system of claim 286, wherein alternative spellings are misspellings.

288. The system of claim 244, wherein the expanded query includes all permutations of query terms and related words.

289. The system of claim 244, wherein the expanded query includes all permutations of related words and no query terms.

290. The system of claim 244, wherein the expanded query includes all permutations of query terms and no related words.

291. The system of claim 244, wherein query parameters are used to alter an expanded query's makeup.

292. The system of claim 291, wherein the alteration limits how many related words are to be used for an expanded query.

293. The system of claim 292, wherein more common words are used when selecting a limited number of related words from a larger set of identified related words.

294. The system of claim 293, wherein the memory includes a database.

295. The system of claim 293, wherein the memory includes an index.

296. The system of claim 293, wherein the memory is on a remote system.

297. The system of claim 293, wherein the memory is distributed across multiple systems.

298. The system of claim 244, wherein references with a greater incidence of matching terms from the expanded query are given higher rankings.

299. The system of claim 244, wherein references with a greater ratio of matching terms from the expanded query as compared to the references' total number of words are given higher rankings.

300. The system of claim 244, wherein references with matching terms that are emphasized from the expanded query are given higher rankings than references with non-emphasized matching terms from the expanded query.

301. The system of claim 300, wherein the identified related words of the matching terms in the expanded query have an emphasis value related to the emphasis value of the matching terms.

302. The system of claim 301, wherein the related emphasis value is the same as the matching terms.

303. The system of claim 301, wherein the related emphasis value decays in value from the emphasis value of the matching terms.

304. The system of claim 244, wherein references falling within query parameters are ranked higher.

305. The system of claim 244, wherein more recent references are ranked higher than older references.

306. The system of claim 244, wherein sponsored references are ranked higher.

307. The system of claim 244, wherein references that more completely satisfy the generated query are ranked higher.

308. The system of claim 244, wherein references that more exactly match query terms from the expanded query are ranked higher.

309. The system of claim 308, wherein more exact matches are characterized by having a word order like the generated query.

310. The system of claim 308, wherein more exact matches are characterized by maintaining similar word proximities as between the generated query.

311. The system of claim 244, further, comprising:
displaying the ranked matching references.

312. A medium readable by a processor to search data, comprising:
instruction signals in the processor readable medium, wherein the instruction signals are issuable by the processor to:
obtain a query;
match terms within the query to words in a dictionary;
identify words related to the matched terms in the dictionary;
generate an expanded query including identified related words;
search memory with the expanded query for matching references;
rank matching references, wherein ranking employs super-targeting; and
provide ranked matching references in response to the obtained query.

313. The medium of claim 312, wherein the dictionary is a dictionary of interassociated words.

314. A medium readable by a processor to search data, comprising:
instruction signals in the processor readable medium, wherein the instruction signals are issuable by the processor to:
obtain a query;
match terms within the query to words in a dictionary of interassociated words;
identify words related to the matched terms in the interassociated words dictionary;
generate an expanded query including identified related words;
search memory with the expanded query for matching references;
rank matching references; and
provide ranked matching references in response to the obtained query.

315. The medium of claim 314, wherein the related words are identified by a user making a selection of a subset of related words identified from the interassociated words dictionary.

316. The medium of claim 314, wherein the query is obtained through voice recognition.

317. The medium of claim 316, wherein the memory being search contains commands that may be executed.

318. The medium of claim 314, wherein a ranking is based on higher scores.

319. The medium of claim 314, wherein a ranking is based on lower scores.

320. The medium of claim 314, wherein a ranking is based on gravity.

321. The medium of claim 314, wherein a ranking is based on uniqueness.

322. The medium of claim 316, wherein a highest ranked matching reference is selected as a command for execution.

323. The medium of claim 314, wherein the query is obtained from a searcher.

324. The medium of claim 314, wherein the query's terms include keywords.

325. The medium of claim 314, wherein the query's terms include parameters.

326. The medium of claim 314, wherein the query's terms include emphasis.

327. The medium of claim 326, wherein the identified related words of the matching terms have an emphasis value related to the emphasis value of the matching terms.

328. The medium of claim 327, wherein the related emphasis value is the same as the matching terms.

329. The medium of claim 327, wherein the related emphasis value decays in value from the emphasis value of the matching terms.

330. The medium of claim 326, wherein an emphasis value is supplied via a user interface.

331. The medium of claim 330, wherein the emphasis value is continuously re-supplied as a user manipulates the user interface and thereby causes provision of re-ranked references.

332. The medium of claim 314, wherein the query's terms include conjunctions.

333. The medium of claim 332, wherein the conjunctions are Boolean operators.

334. The medium of claim 314, further, comprising:
identify terms within the query that are misspelled.

335. The medium of claim 334, wherein the query terms are red against a dictionary.

336. The medium of claim 335, wherein the dictionary is a dictionary of interassociated words.

337. The medium of claim 335, further, comprising:
determine a correct word spelling for the misspelled word and using the correctly spelled word as a query term.

338. The medium of claim 337, wherein the correctly spelled word replaces the misspelled word in the query.

339. The medium of claim 337, wherein the correctly spelled word is used in addition to the misspelled word in the query.

340. The medium of claim 314, further, comprising:
identify words having phonetic similarities to the matching terms in the interassociated words dictionary.

341. The medium of claim 314, further, comprising:
identify partial words related to the matching terms in the interassociated words dictionary.

342. The medium of claim 341, wherein partial related words are identified by determining word roots of query terms.

343. The medium of claim 341, further, comprising:
identify related words for partial words.

344. The medium of claim 314, further, comprising:
identify alternative word spellings related to the query terms in a dictionary.

345. The medium of claim 344, wherein the alternative word spelling is a misspelling.

346. The medium of claim 344, wherein the dictionary is an interassociated words dictionary that is used for identifying alternative spellings.

347. The medium of claim 344, wherein the dictionary is a dictionary of misspellings.

348. The medium of claim 347, wherein common misspellings are related to correct spellings in the dictionary of misspellings.

349. The medium of claim 347, wherein the identified word misspellings are used in addition to the query terms.

350. The medium of claim 349, wherein the word misspellings that are used are common misspellings.

351. The medium of claim 314, further, comprising:
determine if pluralities of the query terms constitute word phrases.

352. The medium of claim 351, wherein a query term's word order within the query is used to determine if a plurality of the matched terms constitute a word phrase.

353. The medium of claim 351, wherein a query term's proximity to other query terms is used to determine if a plurality of the matched terms constitute a word phrase.

354. The medium of claim 351, wherein a query term's word order within the query establishes its grammatical type.

355. The medium of claim 354, wherein a query term's grammatical type within the query is used to emphasize query terms.

356. The medium of claim 354, wherein a query term's grammatical type is used to select related words of a same grammatical type from the dictionary.

357. The medium of claim 314, wherein a query term's word order within the query is used to emphasize query terms.

358. The medium of claim 314, wherein a query term's grammatical type within the query is used to emphasize query terms.

359. The medium of claim 314, further, comprising:
identify related words for alternative word spellings.

360. The medium of claim 314, further, comprising:
identify additional related words for emphasized query terms.

361. The medium of claim 360, wherein the additional related words are identified by recursively identifying words related to previously identified related words.

362. The medium of claim 314, wherein the identified related words further include identified partial words.

363. The medium of claim 314, wherein the identified related words further include equivalent words from languages other than a language used in the obtained query.

364. The medium of claim 363, wherein language translation dictionaries are used to translate the obtained query from one language to another and foreign dictionaries of interassociated words are used to match and identify related words for any translated query terms.

365. The medium of claim 363, wherein parameters allow users to specify languages in which they want a resulting expanded search to be generated.

366. The medium of claim 314, wherein the identified related words further include alternative spellings.

367. The medium of claim 366, wherein alternative spellings are misspellings.

368. The medium of claim 314, wherein the expanded query includes all permutations of query terms and related words.

369. The medium of claim 314, wherein the expanded query includes all permutations of related words and no query terms.

370. The medium of claim 314, wherein the expanded query includes all permutations of query terms and no related words.

371. The medium of claim 314, wherein query parameters are used to alter an expanded query's makeup.

372. The medium of claim 371, wherein the alteration limits how many related words are to be used for an expanded query.

373. The medium of claim 372, wherein more common words are used when selecting a limited number of related words from a larger set of identified related words.

374. The medium of claim 373, wherein the memory includes a database.

375. The medium of claim 373, wherein the memory includes an index.

376. The medium of claim 373, wherein the memory is on a remote system.

377. The medium of claim 373, wherein the memory is distributed across multiple systems.

378. The medium of claim 314, wherein references with a greater incidence of matching terms from the expanded query are given higher rankings.

379. The medium of claim 314, wherein references with a greater ratio of matching terms from the expanded query as compared to the references' total number of words are given higher rankings.

380. The medium of claim 314, wherein references with matching terms that are emphasized from the expanded query are given higher rankings than references with non-emphasized matching terms from the expanded query.

381. The medium of claim 380, wherein the identified related words of the matching terms in the expanded query have an emphasis value related to the emphasis value of the matching terms.

382. The medium of claim 381, wherein the related emphasis value is the same as the matching terms.

383. The medium of claim 381, wherein the related emphasis value decays in value from the emphasis value of the matching terms.

384. The medium of claim 314, wherein references falling within query parameters are ranked higher.

385. The medium of claim 314, wherein more recent references are ranked higher than older references.

386. The medium of claim 314, wherein sponsored references are ranked higher.

387. The medium of claim 314, wherein references that more completely satisfy the obtained query are ranked higher.

388. The medium of claim 314, wherein references that with higher hit density are ranked higher.

389. The medium of claim 314, wherein references that more exactly match query terms from the expanded query are ranked higher.

390. The medium of claim 389, wherein more exact matches are characterized by having a word order like the obtained query.

391. The medium of claim 389, wherein more exact matches are characterized by maintaining similar word proximities as between the obtained query.

392. The medium of claim 314, further, comprising:
displaying the ranked matching references.

393. A medium readable by a processor to provide relevant data, comprising:
instruction signals in the processor readable medium, wherein the instruction signals are issuable by the processor to:
copy words from a web page at a location;
generate a query from unique words from the web page;
match terms within the query to words in a dictionary of interassociated words;
identify words related to the matched terms in the interassociated words dictionary;
generate an expanded query including identified related words;
search memory with the expanded query for matching references;
rank matching references; and
provide ranked matching references in response to the obtained query;
display the ranked references in an information bar in the web browser.

394. The medium of claim 393, wherein duplicate words add emphasis to the unique words constituting the query.

395. A medium readable by a processor to advertise relevant data, comprising:
instruction signals in the processor readable medium, wherein the instruction signals are issuable by the processor to:
copy words from a web page at a location;
generate a query from unique words from the web page;
match terms within the query to words in a dictionary of interassociated words;
identify words related to the matched terms in the interassociated words dictionary;
generate an expanded query including identified related words;
search memory with the expanded query for matching references, wherein the memory includes a database of advertisements;
rank matching references; and
provid ranked matching references in response to the obtained query;
display the ranked references in an advertisement.

396. The medium of claim 395, wherein the related words are identified by a user making a selection of a subset of related words identified from the interassociated words dictionary.

397. The medium of claim 395, wherein the query's terms include keywords.

398. The medium of claim 395, wherein the query's terms include parameters and wherein parameters are specified by constraints provided by the advertiser.

399. The medium of claim 395, wherein the query's terms include emphasis.

400. The medium of claim 399, wherein the identified related words of the matching terms have an emphasis value related to the emphasis value of the matching terms.

401. The medium of claim 400, wherein the related emphasis value is the same as the matching terms.

402. The medium of claim 400, wherein the related emphasis value decays in value from the emphasis value of the matching terms.

403. The medium of claim 395, wherein the query's terms include conjunctions.

404. The medium of claim 403, wherein the conjunctions are Boolean operators.

405. The medium of claim 395, further, comprising:
identify terms within the query that are misspelled.

406. The medium of claim 405, wherein the query terms are compared against a dictionary.

407. The medium of claim 406, wherein the dictionary is a dictionary of interassociated words.

408. The medium of claim 406, further, comprising:
determine a correct word spelling for the misspelled word and using the correctly spelled word as a query term.

409. The medium of claim 408, wherein the correctly spelled word replaces the misspelled word in the query.

410. The medium of claim 408, wherein the correctly spelled word is used in addition to the misspelled word in the query.

411. The medium of claim 395, further, comprising:
identify words having phonetic similarities to the matching terms in the interassociated words dictionary.

412. The medium of claim 395, further, comprising:
identify partial words related to the matching terms in the interassociated words dictionary.

413. The medium of claim 412, wherein partial related words are identified by determining word roots of query terms.

414. The medium of claim 412, further, comprising:
identify related words for partial words.

415. The medium of claim 395, further, comprising:
identify alternative word spellings related to the query terms in a dictionary.

416. The medium of claim 415, wherein the alternative word spelling is a misspelling.

417. The medium of claim 415, wherein the dictionary is an interassociated words dictionary that is used for identifying alternative spellings.

418. The medium of claim 415, wherein the dictionary is a dictionary of misspellings.

419. The medium of claim 418, wherein common misspellings are related to correct spellings in the dictionary of misspellings.

420. The medium of claim 418, wherein the identified word misspellings are used in addition to the query terms.

421. The medium of claim 420, wherein the word misspellings that are used are common misspellings.

422. The medium of claim 395, further, comprising:
determine if pluralities of the query terms constitute word phrases.

423. The medium of claim 422, wherein a query term's word order within the query is used to determine if a plurality of the matched terms constitute a word phrase.

424. The medium of claim 422, wherein a query term's proximity to other query terms is used to determine if a plurality of the matched terms constitute a word phrase.

425. The medium of claim 422, wherein a query term's word order within the query establishes its grammatical type.

426. The medium of claim 425, wherein a query term's grammatical type within the query is used to emphasize query terms.

427. The medium of claim 425, wherein a query term's grammatical type is used to select related words of a same grammatical type from the dictionary.

428. The medium of claim 395, wherein a query term's word order within the query is used to emphasize query terms.

429. The medium of claim 395, wherein a query term's grammatical type within the query is used to emphasize query terms.

430. The medium of claim 395, further, comprising:
identify related words for alternative word spellings.

431. The medium of claim 395, further, comprising:
identify additional related words for emphasized query terms.

432. The medium of claim 431, wherein the additional related words are identified by recursively identifying words related to previously identified related words.

433. The medium of claim 395, wherein the identified related words further include identified partial words.

434. The medium of claim 395, wherein the identified related words further include equivalent words from languages other than a language used in the generated query.

435. The medium of claim 434, wherein language translation dictionaries are used to translate the generated query from one language to another and foreign dictionaries of interassociated words are used to match and identify related words for any translated query terms.

436. The medium of claim 434, wherein parameters allow users to specify languages in which they want a resulting expanded search to be generated.

437. The medium of claim 395, wherein the identified related words further include alternative spellings.

438. The medium of claim 437, wherein alternative spellings are misspellings.

439. The medium of claim 395, wherein the expanded query includes all permutations of query terms and related words.

440. The medium of claim 395, wherein the expanded query includes all permutations of related words and no query terms.

441. The medium of claim 395, wherein the expanded query includes all permutations of query terms and no related words.

442. The medium of claim 395, wherein query parameters are used to alter an expanded query's makeup.

443. The medium of claim 442, wherein the alteration limits how many related words are to be used for an expanded query.

444. The medium of claim 443, wherein more common words are used when selecting a limited number of related words from a larger set of identified related words.

445. The medium of claim 444, wherein the memory includes a database.

446. The medium of claim 444, wherein the memory includes an index.

447. The medium of claim 444, wherein the memory is on a remote system.

448. The medium of claim 444, wherein the memory is distributed across multiple systems.

449. The medium of claim 395, wherein references with a greater incidence of matching terms from the expanded query are given higher rankings.

450. The medium of claim 395, wherein references with a greater ratio of matching terms from the expanded query as compared to the references' total number of words are given higher rankings.

451. The medium of claim 395, wherein references with matching terms that are emphasized from the expanded query are given higher rankings than references with non-emphasized matching terms from the expanded query.

452. The medium of claim 451, wherein the identified related words of the matching terms in the expanded query have an emphasis value related to the emphasis value of the matching terms.

453. The medium of claim 452, wherein the related emphasis value is the same as the matching terms.

454. The medium of claim 452, wherein the related emphasis value decays in value from the emphasis value of the matching terms.

455. The medium of claim 395, wherein references falling within query parameters are ranked higher.

456. The medium of claim 395, wherein more recent references are ranked higher than older references.

457. The medium of claim 395, wherein sponsored references are ranked higher.

458. The medium of claim 395, wherein references that more completely satisfy the generated query are ranked higher.

459. The medium of claim 395, wherein references that more exactly match query terms from the expanded query are ranked higher.

460. The medium of claim 459, wherein more exact matches are characterized by having a word order like the generated query.

461. The medium of claim 459, wherein more exact matches are characterized by maintaining similar word proximities as between the generated query.

462. The medium of claim 395, further, comprising:
displaying the ranked matching references.

463. An apparatus to search data, comprising:
a memory;
a processor disposed in communication with said memory, and configured to issue a plurality of processing instructions stored in the memory, wherein the instructions issue signals to:
obtain a query;
match terms within the query to words in a dictionary;
identify words related to the matched terms in the dictionary;
generate an expanded query including identified related words;
search memory with the expanded query for matching references;
rank matching references, wherein ranking employs super-targeting; and
provide ranked matching references in response to the obtained query.

464. The apparatus of claim 463, wherein the dictionary is a dictionary of interassociated words.

465. An apparatus to search data, comprising:
a memory;
a processor disposed in communication with said memory, and configured to issue a
plurality of processing instructions stored in the memory, wherein the instructions issue signals to:
obtain a query;
match terms within the query to words in a dictionary of interassociated words;
identify words related to the matched terms in the interassociated words dictionary;
generate an expanded query including identified related words;
search memory with the expanded query for matching references;
rank matching references; and
provide ranked matching references in response to the obtained query.

466. The apparatus of claim 465, wherein the related words are identified by a user making a selection of a subset of related words identified from the interassociated words dictionary.

467. The apparatus of claim 465, wherein the query is obtained through voice recognition.

468. The apparatus of claim 467, wherein the memory being search contains commands that may be executed.

469. The apparatus of claim 465, wherein a ranking is based on higher scores.

470. The apparatus of claim 465, wherein a ranking is based on lower scores.

471. The apparatus of claim 465, wherein a ranking is based on gravity.

472. The apparatus of claim 465, wherein a ranking is based on uniqueness.

473. The apparatus of claim 467, wherein a highest ranked matching reference is selected as a command for execution.

474. The apparatus of claim 465, wherein the query is obtained from a searcher.

475. The apparatus of claim 465, wherein the query's terms include keywords.

476. The apparatus of claim 465, wherein the query's terms include parameters.

477. The apparatus of claim 465, wherein the query's terms include emphasis.

478. The apparatus of claim 477, wherein the identified related words of the matching terms have an emphasis value related to the emphasis value of the matching terms.

479. The apparatus of claim 478, wherein the related emphasis value is the same as the matching terms.

480. The apparatus of claim 478, wherein the related emphasis value decays in value from the emphasis value of the matching terms.

481. The apparatus of claim 477, wherein an emphasis value is supplied via a user interface.

482. The apparatus of claim 481, wherein the emphasis value is continuously re-supplied as a user manipulates the user interface and thereby causes provision of re-ranked references.

483. The apparatus of claim 465, wherein the query's terms include conjunctions.

484. The apparatus of claim 483, wherein the conjunctions are Boolean operators.

485. The apparatus of claim 465, further, comprising:
identify terms within the query that are misspelled.

486. The apparatus of claim 485, wherein the query terms are compared against a dictionary.

487. The apparatus of claim 486, wherein the dictionary is a dictionary of interassociated words.

488. The apparatus of claim 486, further, comprising:
determine a correct word spelling for the misspelled word and using the correctly spelled word as a query term.

489. The apparatus of claim 488, wherein the correctly spelled word replaces the misspelled word in the query.

490. The apparatus of claim 488, wherein the correctly spelled word is used in addition to the misspelled word in the query.

491. The apparatus of claim 465, further, comprising:
identify words having phonetic similarities to the matching terms in the interassociated words dictionary.

492. The apparatus of claim 465, further, comprising:
identify partial words related to the matching terms in the interassociated words dictionary.

493. The apparatus of claim 492, wherein partial related words are identified by determining word roots of query terms.

494. The apparatus of claim 492, further, comprising:
identify related words for partial words.

495. The apparatus of claim 465, further, comprising:
identify alternative word spellings related to the query terms in a dictionary.

496. The apparatus of claim 495, wherein the alternative word spelling is a misspelling.

497. The apparatus of claim 495, wherein the dictionary is an interassociated words dictionary that is used for identifying alternative spellings.

498. The apparatus of claim 495, wherein the dictionary is a dictionary of misspellings.

499. The apparatus of claim 498, wherein common misspellings are related to correct spellings in the dictionary of misspellings.

500. The apparatus of claim 498, wherein the identified word misspellings are used in addition to the query terms.

501. The apparatus of claim 500, wherein the word misspellings that are used are common misspellings.

502. The apparatus of claim 465, further, comprising:
determine if pluralities of the query terms constitute word phrases.

503. The apparatus of claim 502, wherein a query term's word order within the query is used to determine if a plurality of the matched terms constitute a word phrase.

504. The apparatus of claim 502, wherein a query term's proximity to other query terms is used to determine if a plurality of the matched terms constitute a word phrase.

505. The apparatus of claim 502, wherein a query term's word order within the query establishes its grammatical type.

506. The apparatus of claim 505, wherein a query term's grammatical type within the query is used to emphasize query terms.

507. The apparatus of claim 505, wherein a query term's grammatical type is used to select related words of a same grammatical type from the dictionary.

508. The apparatus of claim 465, wherein a query term's word order within the query is used to emphasize query terms.

509. The apparatus of claim 465, wherein a query term's grammatical type within the query is used to emphasize query terms.

510. The apparatus of claim 465, further, comprising:
identify related words for alternative word spellings.

511. The apparatus of claim 465, further, comprising:
identify additional related words for emphasized query terms.

512. The apparatus of claim 511, wherein the additional related words are identified by recursively identifying words related to previously identified related words.

513. The apparatus of claim 465, wherein the identified related words further include identified partial words.

514. The apparatus of claim 465, wherein the identified related words further include equivalent words from languages other than a language used in the obtained query.

515. The apparatus of claim 514, wherein language translation dictionaries are used to translate the obtained query from one language to another and foreign dictionaries of interassociated words are used to match and identify related words for any translated query terms.

516. The apparatus of claim 514, wherein parameters allow users to specify languages in which they want a resulting expanded search to be generated.

517. The apparatus of claim 465, wherein the identified related words further include alternative spellings.

518. The apparatus of claim 517, wherein alternative spellings are misspellings.

519. The apparatus of claim 465, wherein the expanded query includes all permutations of query terms and related words.

520. The apparatus of claim 465, wherein the expanded query includes all permutations of related words and no query terms.

521. The apparatus of claim 465, wherein the expanded query includes all permutations of query terms and no related words.

522. The apparatus of claim 465, wherein query parameters are used to alter an expanded query's makeup.

523. The apparatus of claim 522, wherein the alteration limits how many related words are to be used for an expanded query.

524. The apparatus of claim 523, wherein more common words are used when selecting a limited number of related words from a larger set of identified related words.

525. The apparatus of claim 524, wherein the memory includes a database.

526. The apparatus of claim 524, wherein the memory includes an index.

527. The apparatus of claim 524, wherein the memory is on a remote system.

528. The apparatus of claim 524, wherein the memory is distributed across multiple systems.

529. The apparatus of claim 465, wherein references with a greater incidence of matching terms from the expanded query are given higher rankings.

530. The apparatus of claim 465, wherein references with a greater ratio of matching terms from the expanded query as compared to the references' total number of words are given higher rankings.

531. The apparatus of claim 465, wherein references with matching terms that are emphasized from the expanded query are given higher rankings than references with non-emphasized matching terms from the expanded query.

532. The apparatus of claim 531, wherein the identified related words of the matching terms in the expanded query have an emphasis value related to the emphasis value of the matching terms.

533. The apparatus of claim 532, wherein the related emphasis value is the same as the matching terms.

534. The apparatus of claim 532, wherein the related emphasis value decays in value from the emphasis value of the matching terms.

535. The apparatus of claim 465, wherein references falling within query parameters are ranked higher.

536. The apparatus of claim 465, wherein more recent references are ranked higher than older references.

537. The apparatus of claim 465, wherein sponsored references are ranked higher.

538. The apparatus of claim 465, wherein references that more completely satisfy the obtained query are ranked higher.

539. The apparatus of claim 465, wherein references that with higher hit density are ranked higher.

540. The apparatus of claim 465, wherein references that more exactly match query terms from the expanded query are ranked higher.

541. The apparatus of claim 540, wherein more exact matches are characterized by having a word order like the obtained query.

542. The apparatus of claim 540, wherein more exact matches are characterized by maintaining similar word proximities as between the obtained query.

543. The apparatus of claim 465, further, comprising:
displaying the ranked matching references.

544. An apparatus to provide relevant data, comprising:
a memory;
a processor disposed in communication with said memory, and configured to issue a plurality of processing instructions stored in the memory, wherein the instructions issue signals to:
copy words from a web page at a location;
generate a query from unique words from the web page;
match terms within the query to words in a dictionary of interassociated words;
identify words related to the matched terms in the interassociated words dictionary;
generate an expanded query including identified related words;
search memory with the expanded query for matching references;
rank matching references; and
provide ranked matching references in response to the obtained query;
display the ranked references in an information bar in the web browser.

545. The apparatus of claim 544, wherein duplicate words add emphasis to the unique words constituting the query.

546. An apparatus to advertise relevant data, comprising:
a memory;
a processor disposed in communication with said memory, and configured to issue a plurality of processing instructions stored in the memory, wherein the instructions issue signals to:
copy words from a web page at a location;
generate a query from unique words from the web page;
match terms within the query to words in a dictionary of interassociated words;
identify words related to the matched terms in the interassociated words dictionary;
generate an expanded query including identified related words;
search memory with the expanded query for matching references, wherein the memory includes a database of advertisements;
rank matching references; and
provid ranked matching references in response to the obtained query;
display the ranked references in an advertisement.

547. The apparatus of claim 546, wherein the related words are identified by a user making a selection of a subset of related words identified from the interassociated words dictionary.

548. The apparatus of claim 546, wherein the query's terms include keywords.

549. The apparatus of claim 546, wherein the query's terms include parameters and wherein parameters are specified by constraints provided by the advertiser.

550. The apparatus of claim 546, wherein the query's terms include emphasis.

551. The apparatus of claim 550, wherein the identified related words of the matching terms have an emphasis value related to the emphasis value of the matching terms.

552. The apparatus of claim 551, wherein the related emphasis value is the same as the matching terms.

553. The apparatus of claim 551, wherein the related emphasis value decays in value from the emphasis value of the matching terms.

554. The apparatus of claim 546, wherein the query's terms include conjunctions.

555. The apparatus of claim 554, wherein the conjunctions are Boolean operators.

556. The apparatus of claim 546, further, comprising:
identify terms within the query that are misspelled.

557. The apparatus of claim 556, wherein the query terms are compared against a dictionary.

558. The apparatus of claim 557, wherein the dictionary is a dictionary of interassociated words.

559. The apparatus of claim 557, further, comprising:
determine a correct word spelling for the misspelled word and using the correctly spelled word as a query term.

560. The apparatus of claim 559, wherein the correctly spelled word replaces the misspelled word in the query.

561. The apparatus of claim 559, wherein the correctly spelled word is used in addition to the misspelled word in the query.

562. The apparatus of claim 546, further, comprising:
identify words having phonetic similarities to the matching terms in the interassociated words dictionary.

563. The apparatus of claim 546, further, comprising:
identify partial words related to the matching terms in the interassociated words dictionary.

564. The apparatus of claim 563, wherein partial related words are identified by determining word roots of query terms.

565. The apparatus of claim 563, further, comprising:
identify related words for partial words.

566. The apparatus of claim 546, further, comprising:
identify alternative word spellings related to the query terms in a dictionary.

567. The apparatus of claim 566, wherein the alternative word spelling is a misspelling.

568. The apparatus of claim 566, wherein the dictionary is an interassociated words dictionary that is used for identifying alternative spellings.

569. The apparatus of claim 566, wherein the dictionary is a dictionary of misspellings.

570. The apparatus of claim 569, wherein common misspellings are related to correct spellings in the dictionary of misspellings.

571. The apparatus of claim 569, wherein the identified word misspellings are used in addition to the query terms.

572. The apparatus of claim 571, wherein the word misspellings that are used are common misspellings.

573. The apparatus of claim 546, further, comprising:
determine if pluralities of the query terms constitute word phrases.

574. The apparatus of claim 573, wherein a query term's word order within the query is used to determine if a plurality of the matched terms constitute a word phrase.

575. The apparatus of claim 573, wherein a query term's proximity to other query terms is used to determine if a plurality of the matched terms constitute a word phrase.

576. The apparatus of claim 573, wherein a query term's word order within the query establishes its grammatical type.

577. The apparatus of claim 576, wherein a query term's grammatical type within the query is used to emphasize query terms.

578. The apparatus of claim 576, wherein a query term's grammatical type is used to select related words of a same grammatical type from the dictionary.

579. The apparatus of claim 546, wherein a query term's word order within the query is used to emphasize query terms.

580. The apparatus of claim 546, wherein a query term's grammatical type within the query is used to emphasize query terms.

581. The apparatus of claim 546, further, comprising:
identify related words for alternative word spellings.

582. The apparatus of claim 546, further, comprising:
identify additional related words for emphasized query terms.

583. The apparatus of claim 582, wherein the additional related words are identified by recursively identifying words related to previously identified related words.

584. The apparatus of claim 546, wherein the identified related words further include identified partial words.

585. The apparatus of claim 546, wherein the identified related words further include equivalent words from languages other than a language used in the generated query.

586. The apparatus of claim 585, wherein language translation dictionaries are used to translate the generated query from one language to another and foreign dictionaries of interassociated words are used to match and identify related words for any translated query terms.

587. The apparatus of claim 585, wherein parameters allow users to specify languages in which they want a resulting expanded search to be generated.

588. The apparatus of claim 546, wherein the identified related words further include alternative spellings.

589. The apparatus of claim 588, wherein alternative spellings are misspellings.

590. The apparatus of claim 546, wherein the expanded query includes all permutations of query terms and related words.

591. The apparatus of claim 546, wherein the expanded query includes all permutations of related words and no query terms.

592. The apparatus of claim 546, wherein the expanded query includes all permutations of query terms and no related words.

593. The apparatus of claim 546, wherein query parameters are used to alter an expanded query's makeup.

594. The apparatus of claim 593, wherein the alteration limits how many related words are to be used for an expanded query.

595. The apparatus of claim 594, wherein more common words are used when selecting a limited number of related words from a larger set of identified related words.

596. The apparatus of claim 595, wherein the memory includes a database.

597. The apparatus of claim 595, wherein the memory includes an index.

598. The apparatus of claim 595, wherein the memory is on a remote system.

599. The apparatus of claim 595, wherein the memory is distributed across multiple systems.

600. The apparatus of claim 546, wherein references with a greater incidence of matching terms from the expanded query are given higher rankings.

601. The apparatus of claim 546, wherein references with a greater ratio of matching terms from the expanded query as compared to the references' total number of words are given higher rankings.

602. The apparatus of claim 546, wherein references with matching terms that are emphasized from the expanded query are given higher rankings than references with non-emphasized matching terms from the expanded query.

603. The apparatus of claim 602, wherein the identified related words of the matching terms in the expanded query have an emphasis value related to the emphasis value of the matching terms.

604. The apparatus of claim 603, wherein the related emphasis value is the same as the matching terms.

605. The apparatus of claim 603, wherein the related emphasis value decays in value from the emphasis value of the matching terms.

606. The apparatus of claim 546, wherein references falling within query parameters are ranked higher.

607. The apparatus of claim 546, wherein more recent references are ranked higher than older references.

608. The apparatus of claim 546, wherein sponsored references are ranked higher.

609. The apparatus of claim 546, wherein references that more completely satisfy the generated query are ranked higher.

610. The apparatus of claim 546, wherein references that more exactly match query terms from the expanded query are ranked higher.

611. The apparatus of claim 610, wherein more exact matches are characterized by having a word order like the generated query.

612. The apparatus of claim 610, wherein more exact matches are characterized by maintaining similar word proximities as between the generated query.

613. The apparatus of claim 546, further, comprising:
displaying the ranked matching references.
